(19) United States
(12) Patent Application Publication
(10) Pub. No.: US 2026/0193803 A1
(43) Pub. Date: Jul. 9, 2026

(54) Methods and Systems for Electrolytic Upcycling of Sulfate Waste during Resource Extraction for Carbon Dioxide Mineralization

(71) Applicant: Travertine Technologies, Inc., Boulder, CO (US)

(72) Inventors: Laura N. Lammers, Boulder, CO (US); Benjamin Kronholm, Boulder, CO (US); Roxanna Delima, Boulder, CO (US)

(21) Appl. No.: 19/359,450

(22) Filed: Oct. 15, 2025

Related U.S. Application Data
(63) Continuation of application No. 19/100,049, filed on Feb. 1, 2024.
(60) Provisional application No. 63/443,268, filed on Feb. 3, 2023.
(60) Provisional application No. 63/538,371, filed on Sep. 14, 2023.

(51) Int. Cl. C25B 15/08; B01D 53/62; B01D 53/78; B01D 61/44; C01F 5/24; C01F 11/18; C25B 1/16; C25B 1/20; C25B 1/22; C25B 9/77

(52) U.S. Cl. CPC C25B 15/087; B01D 53/62; B01D 53/78; B01D 61/445; C01F 5/24; C01F 11/18; C25B 1/16; C25B 1/20; C25B 1/22; C25B 9/77; B01D 2251/304; B01D 2251/604; B01D 2257/504

(57) ABSTRACT

Methods of electrolytic upcycling of sulfate waste during resource extraction are provided. Methods of interest include electrolyzing an aqueous sulfate to produce an acidic solution and a basic solution, wherein the electrolyzing comprises the use of an electrolyzer stack of one or more electrochemical cells comprising an anode within an anode chamber containing an anolyte, a cathode within a cathode chamber containing a catholyte, and a cation exchange membrane separating the anode and cathode chambers. Methods also include extracting a mineral from a mineral source using the acidic solution, thereby producing a sulfate waste product, precipitating an inorganic alkaline solid formed from the sulfate waste product, thereby regenerating the aqueous sulfate, and recirculating the regenerated aqueous sulfate to the electrolyzer stack for electrolysis. Systems for practicing the invention are also provided.

### CROSS-REFERENCE TO RELATED APPLICATIONS

This application is a continuation of U.S. application Ser. No. 19/100,049 filed on Jan. 30, 2025, which application is a United States National Stage Application of PCT Application No. PCT/US2024/014042 filed Feb. 1, 2024, which application, pursuant to 35 U.S.C. § 119(e), claims priority to the filing dates of U.S. Provisional Application Ser. No. 63/443,268 filed on Feb. 3, 2023 and U.S. Provisional Application Ser. No. 63/538,371 filed on Sep. 14, 2023; the disclosures of which applications are herein incorporated by reference.

### INTRODUCTION

Global anthropogenic carbon dioxide (CO₂) emissions are approximately 50 gigatons per year, and affordable solutions to durably sequester CO₂ are needed to prevent catastrophic climate change (Mac Dowell et al., 2017; Sullivan et al., 2021). Recent IPCC projections indicate that around 6 billion metric tons (Gt) per year of direct air capture of CO₂ with durable storage (DACS) are required to reduce atmospheric CO₂ concentrations to levels that safely limit global warming (Riahi, 2022). To match the large scale of global CO₂ emissions, scientists have turned to natural processes for inspiration. Formation of carbonate minerals represents a safe, stable, and geologically permanent way to remove and sequester CO₂ (Lal, 2008; Mac Dowell et al., 2022), but mineral carbonation requires both a source of CO₂-reactive elements (e.g., calcium and magnesium) and a permanent sink for acidity (i.e., an alkaline material). Over geologic timescales, the weathering of silicate rocks at Earth's surface supplies the ingredients for mineral carbonation to regulate the global atmospheric CO₂ concentration (Blattler and Higgins, 2017; Sleep and Zahnle, 2001), in a process known as the Urey Cycle. Importantly, the Urey Cycle is driven by the ability of rock forming minerals to neutralize acid, as measured by their acid neutralizing potential (ANP), driving CO₂ dissolution into water and subsequent precipitation of solid carbonate minerals.

Achieving cost-effective carbon dioxide removal (CDR) that can be scaled to gigatons per year of CO₂ sequestration poses a major technological challenge. Direct air capture of CO₂ is energy intensive, and many leading direct air capture technologies require several gigajoules of energy—often as heat—to sequester one ton of CO₂ (Osman et al., 2021; Zeman, 2007). Production of valuable co-products, such as cement products (La Plante et al., 2021; Rau et al., 2018; Rau et al., 2013), or coupling carbon removal with existing extractive processes (Lu et al., 2022) can help improve the economic viability of CDR. The mining industry processes billions of tons of rock every year to extract critical elements for electrified energy generation and storage (e.g., copper, and lithium) and for the fertilizer industry (e.g., phosphorus). Of the billions of tons of tailings and waste rock produced, around 420 Mt consist of basic or ultramafic rocks that have the potential to sequester ~175 Mt of CO₂ annually (Power et al., 2013a; Power et al., 2013b). Tailings reprocessing can recover critical elements left behind in mine wastes (Grguric et al., 2006), so coupling tailings carbonation with critical element recovery can mitigate the cost of CDR.

Natural rock weathering reactions are too slow to abate human emissions, so many physical and chemical approaches have been developed to accelerate the rate of tailings weathering for CDR (Bea et al., 2012; Lackner, 2002; Lu et al., 2022; Meyer et al., 2014; Wilson et al., 2006; Wilson et al., 2009; Woodall et al., 2021). Chemical “pH-swing” methods combining acid-accelerated primary silicate mineral dissolution with subsequent base addition can drive rapid carbon mineralization over timescales of hours to days (Hamilton et al., 2020; Lu et al., 2022; McCutcheon et al., 2015; Ncongwane et al., 2018; Vogeli et al., 2011), because silicate weathering reaction rates increase exponentially with decreasing pH (Pokrovsky and Schott, 2000). The addition of a strong acid such as sulfuric or hydrochloric acid to mafic and ultramafic silicate tailings has been shown to accelerate weathering and can produce neutralized leachates that minimize heavy metal leaching (Hamilton et al., 2018). The overall reaction for strong acid enhanced ultramafic weathering of a representative mineral, forsterite, is given,

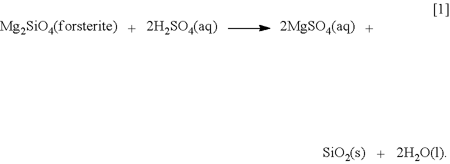

Subsequent carbonation of acid-leached magnesium requires stoichiometric addition of alkalinity to generate solid carbonates (Hamilton et al., 2020; Ncongwane et al., 2018), for example,

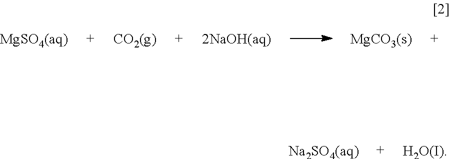

Such pH-swing approaches have been shown to effectively accelerate weathering and carbonation of a variety of tailings and waste rock feedstocks, but the overall process is usually net carbon emitting given the need for stoichiometric quantities of acid and base (Ncongwane et al., 2018).

Rock phosphorus represents another major geological alkalinity source that is largely overlooked in the mineral carbon sequestration literature. Production of phosphoric acid (H₃PO₄) for fertilizer consumes around 60% of the global sulfuric acid supply and generates 200-300 Mt of waste gypsum (i.e., phosphogypsum, or PG) annually (King et al., 2013). Phosphogypsum has been suggested as a feedstock for permanent mineral carbon sequestration, but this process requires two equivalents of alkalinity per mole of gypsum converted to calcium carbonate (Azdarpour et al., 2014; Mattila and Zevenhoven, 2015; Rahmani, 2018; Rahmani et al., 2014; Ruiz-Agudo et al., 2015; Yu et al., 2019). Like enhanced rock weathering, rock phosphorus processing neutralizes sulfuric acid to produce a weak acid, phosphoric acid, by the reaction,

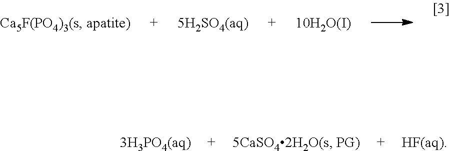

In alkaline solutions containing a strong base such as NaOH, the produced solid PG can be readily converted into carbonate minerals,

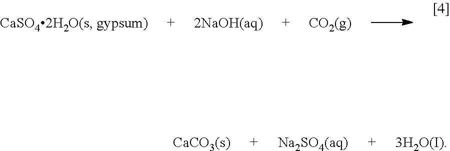

Large-scale replacement of gypsum to carbonate minerals has been observed in rock formations (Wigley, 1973). Importantly, the replacement reaction (Reaction 4) is not passivating: With sufficient carbonate alkalinity, conversion of solid gypsum to solid calcium carbonate can proceed rapidly to completion (Ferndndez-Diaz et al., 2009; Ruiz-Agudo et al., 2015; Yu et al., 2019). If CO₂ can be mineralized on an equimolar basis with gypsum consumption, the ANP realized during phosphate fertilizer production can theoretically sequester 50-75 Mt/y CO₂ today.

### SUMMARY

Given the need for gigaton scale carbon dioxide removal that is affordable and permanent, the present inventors have realized that there is a pressing need for scalable solutions that co-produce valuable products. The inventors have also realized that strong acid extraction of critical element resources such as phosphorus (P), lithium (Li), cobalt (Co), platinum group metals (ruthenium, rhodium, palladium, osmium, iridium, and platinum; referred to as “PGMs”), etc. from geological materials can enable large-scale carbon dioxide removal and sequestration but that it is desirable to develop sources of acid for leaching and base for subsequent mineralization that are economically viable and net carbon-sequestering. In addition, the inventors have found that conventional extractive processes generate large quantities of sulfate chemical waste that contaminate the environment, and it is imperative that approaches for critical element extraction that minimize chemical waste be developed. The methods and systems of the invention satisfy these and other needs.

Methods of the invention include electrolyzing an aqueous sulfate to produce an acidic solution and a basic solution using an electrolyzer stack of one or more electrochemical cells comprising an anode within an anode chamber containing an anolyte, a cathode within a cathode chamber containing a catholyte, and a cation exchange membrane separating the anode and cathode chambers. Methods also include extracting a mineral from a mineral source using the acidic solution, thereby producing a sulfate waste product, precipitating an inorganic alkaline solid formed from the sulfate waste product, thereby regenerating the aqueous sulfate, and recirculating the regenerated aqueous sulfate to the electrolyzer stack for electrolysis. In some embodiments, solid calcium and/or magnesium carbonate, hydroxide, and/or hydroxycarbonate solids are produced. In some such embodiments, the methods involve the use of a cation exchange membrane separated two-chamber cell system, a three-chamber cell system containing both an anion exchange membrane and a cation exchange membrane, or a bipolar membrane electrodialysis (BMED) system comprising a stack of cells with an anion exchange membrane, a cation exchange membrane, and a bipolar membrane. In some cases, the cation exchange membrane is configured so that cations (such as Na⁺) cross the cation exchange membrane to the cathode chamber. In some versions, the one or more electrolysis cells further comprise an anion exchange membrane. In some such cases, the anion exchange membrane is configured so that sulfate anion (SO₄²⁻) crosses the anion exchange membrane to the anode chamber. In select versions, the one or more electrolysis cells further comprise a bipolar membrane. In some such versions, methods include bipolar membrane electrodialysis (BMED).

In certain embodiments, methods of the invention involve a CO₂ sequestering protocol. Such protocols may include, for example, direct air capture (DAC). Additionally, or alternatively, the CO₂ sequestering protocol comprises sequestering gaseous CO₂ from a point source (e.g., a flue gas). The CO₂ sequestering protocol may, in select instances, include reacting gaseous CO₂ with the basic solution generated via electrolysis or electrodialysis to produce an aqueous carbonate solution. The aqueous carbonate solution may also be comprised of aqueous bicarbonate. Methods according to some versions of the invention may include producing a concentrated basic solution, such as where the concentration of the basic solution ranges from 0.5 M to 2 M and the pH of the basic solution ranges from 13.7 to 14.3. The basic solution may, in certain instances, be an alkaline solution. In some such instances, the alkaline solution comprises ammonia (NH₃). In certain versions, methods include concentrating the acidic solution. In some such versions, the concentration of the acidic solution is 0.1 M or greater. Additionally, the pH of the acidic solution may range from −1 to 1. The acidic solution may be comprised of one or more different acids, including but not limited to sulfuric acid (H₂SO₄), hydrochloric acid (HCl), and hydrofluoric acid (HF).

Any convenient inorganic alkaline solid may be produced via the subject methods (e.g., solid calcium and/or magnesium carbonate, hydroxide, and/or hydroxycarbonate solids). In some embodiments, the inorganic alkaline solid is precipitated calcium carbonate (PCC). In additional embodiments, the inorganic alkaline solid is magnesium carbonate (MgCO₃). In still further embodiments, the inorganic alkaline solid is magnesium hydroxy carbonate (Mg₅(CO₃)₄(OH)₂·nH₂O). In some instances, the inorganic alkaline solid is a calcium hydroxide alkaline solid product. In further instances, the inorganic alkaline solid is a magnesium or calcium hydroxide alkaline solid product.

Methods according to some embodiments also include treating the regenerated aqueous sulfate prior to recirculating it to the electrolyzer stack (e.g., subjecting the aqueous sulfate to a brine reformation/purification process). Such can include passing the regenerated aqueous sulfate through a filter or ion exchange resin. In embodiments, methods include concentrating the regenerated aqueous sulfate prior to recirculating it to the electrolyzer stack. In some embodiments, the concentration of the regenerated aqueous sulfate ranges from 0.5 M to saturation. The aqueous sulfate may vary, and can include, but is not limited to, sodium sulfate (Na₂SO₄), potassium sulfate (K₂SO₄), lithium sulfate (Li₂SO₄), and ammonium sulfate ((NH₄)₂SO₄).

In some cases, gaseous hydrogen and oxygen can be separately produced in the electrochemical system and recovered for suitable use. Select embodiments of the methods also include maintaining a concentration of base in the catholyte or the center chamber that is low relative to the concentration of acid in the anolyte or the acid chamber, and recirculating fluid through the cathode chamber and the center chamber when present. One product of the subject methods may be sulfuric acid (H₂SO₄). Such H₂SO₄ may be employed to extract valuable critical elements and calcium and/or magnesium sulfate by strong acid leaching of geological materials. In some instances, the electrolytically produced sulfuric acid is recycled for use in extractive processes. For example, the H₂SO₄ may be used to produce lithium sulfate by reaction with lithium claystone material. In additional embodiments, the H₂SO₄ may be used to produce wet phosphoric acid (WPA) from rock phosphorus, followed by reaction of WPA with ammonia to produce monoammonium phosphate or diammonium phosphate fertilizer. In still more examples, methods include r cobalt production from ultramafic rock or mine tailing materials and produced sulfuric acid. In some cases, the system is configured as a continuous flow system. The critical elements produced via the subject methods may be any convenient solid, liquid, or aqueous form that may be subsequently processed for use in a variety of applications such as lithium used as a component of batteries, or phosphorus used in production of agricultural fertilizers. In some such cases, the sulfuric acid produced by electrolysis may be reconcentrated by a convenient method such as mechanical vapor recompression (MVR) or multi-effect evaporation from the produced concentration up to a maximum azeotropic concentration (~98.5 wt. % H₂SO₄ in water) for use in extractive processes.

Aspects of the invention include efficient processes for CO₂ mineralization using carbon dioxide reactive elements extracted from geological materials using a strong acid such as sulfuric acid. The approach addresses the large acid and base requirements associated with pH-swing CDR. Inputs to the process include geological materials containing carbon dioxide reactive elements such as calcium or magnesium, CO₂ from the air or from point sources, and electricity, and products of the process include solid or aqueous critical element extraction products (e.g., phosphorus, lithium, cobalt, etc.), solid calcium and/or magnesium carbonate and/or hydroxide solids with or without produced hydrogen gas. The process can achieve chemical production efficiencies on par with the industrialized chlor-alkali process, enabling substantial net-removal of CO₂ from air enabled by the neutralization of strong acid by geologic material feedstocks.

Aspects of the invention additionally include systems configured to carry out the subject methods. Systems of interest include an electrolyzer configured to electrolyze an aqueous sulfate to produce an acidic solution and a basic solution, the electrolyzer comprising an electrolyzer stack of one or more electrochemical cells comprising an anode within an anode chamber containing an anolyte, a cathode within a cathode chamber containing a catholyte, and a cation exchange membrane separating the anode and cathode chambers. Systems additionally include a reactor configured to extract a mineral from a mineral source using the acidic solution, thereby producing a sulfate waste product, and a precipitator configured to precipitate an inorganic alkaline solid formed from the sulfate waste product, thereby regenerating the aqueous sulfate. Precipitators of interest are fluidically connected to the electrolyzer stack such that the regenerated aqueous sulfate is recirculated to the electrolyzer stack for electrolysis.

Aspects of the invention include methods and systems that employ strong acid extraction of geologic materials that contain calcium and/or magnesium as well as critical elements, followed by metal and critical element separation and production of calcium and/or magnesium carbonate, hydroxide, and/or hydroxycarbonate solids. Aspects of the methods include an electrochemical system that receives sulfate-rich solid or aqueous acid extraction products, such as solid calcium sulfate or aqueous magnesium sulfate, to produce precipitated calcium and/or magnesium carbonate, hydroxide, and/or hydroxycarbonate solids as well as sulfuric acid in a series of steps. Methods of making precipitated calcium and/or magnesium carbonate, hydroxide, and/or hydroxycarbonate solids using base (such as NaOH) produced in the electrochemical process are provided. In some aspects the geological material that is acid leached for critical element extraction, such as rock phosphate or ultramafic mine tailings, consume acidity in reaction with sulfuric acid, and this neutralization process enables net carbon dioxide sequestration.

### BRIEF DESCRIPTION OF THE FIGURES

FIG. 1 presents a flow chart for practicing a method according to certain embodiments of the invention.

FIGS. 2A-2D present electrolyzer configurations shown with sodium sulfate electrolyte streams according to certain embodiments.

FIG. 3 presents a schematic flow diagram of a system according to certain embodiments of the invention.

FIGS. 4A-4C depict flow diagrams for phosphogypsum upcycling. FIG. 4A shows a three-compartment electrochemical system where sodium sulfate is converted to sodium hydroxide (0.5-2.0M), sulfuric acid (0.5-1.5M), hydrogen and oxygen; an air contactor where sodium hydroxide is converted to sodium (bi)carbonate; a series of metathesis reactors where solid calcium sulfate is converted to calcium carbonate; a series of carbonate reactors where residual calcium is precipitated from the sulfate stream; and, a series of water treatment steps where the sodium sulfate brine is purified and returned to the electrolyzer. FIG. 4B depicts calcium sulfate being introduced to the carbonate precipitation reactor via phosphogypsum leaching rather than via metathesis. FIG. 4C depicts carbon dioxide being reacted with base solution via point source capture rather than direct air capture.

FIGS. 5A-5D depict systems configured to carry out sulfuric acid leaching and accelerated chemical weathering of geological material, such as ultramafic mine tailings, with carbon dioxide removal and permanent sequestration and critical element extraction. The silicate leaching reactor (502) in FIG. 5A can be operated in several configurations; heap, vat (co-current or counter-current), and agitated (co-current or counter-current). FIG. 5B depicts leaching of geological material by vat leaching rather than via a single-step agitated or heap leach. FIGS. 5C-5D depict an optional addition of multi-stage neutralization to produce several hydrolysis products including a mixed hydroxide precipitate to selectively separate metals such as cobalt.

FIGS. 6A-6D present flow diagrams for systems configured to carry out sulfate waste upcycling. FIG. 6A depicts magnesium sulfate (MgSO₄·7H₂O, s) waste upcycling to sulfuric acid, magnesium carbonate and magnesium hydroxide, hydrogen and oxygen, with point source capture of carbon dioxide. FIG. 6B depicts a system that receives neutralized leachate (process leach solution, PLS) from sulfuric acid extraction of lithium ore, such as lithium claystone, and converts the aqueous magnesium sulfate to solid magnesium carbonate and magnesium hydroxide, sulfuric acid, hydrogen and oxygen, with point source capture of carbon dioxide. FIG. 6C depicts magnesium sulfate (MgSO₄·7H₂O, s) waste upcycling to sulfuric acid, magnesium carbonate and magnesium hydroxide, hydrogen and oxygen, with direct air capture of carbon dioxide. FIG. 6D depicts a system that receives neutralized leachate (Li PLS) from sulfuric acid extraction of lithium ore, such as lithium claystone, and converts the aqueous magnesium sulfate to solid magnesium carbonate and magnesium hydroxide, sulfuric acid, hydrogen and oxygen, with direct air capture of carbon dioxide.

FIGS. 7A-7B present time evolution of the calcium concentration and extent of carbonate precipitation.

FIG. 8 presents carbon dioxide uptake rate in a bench-top air contactor as a function of the sodium hydroxide solution concentration.

FIGS. 9A-9H present experimental results produced from systems of the invention.

FIG. 10 presents experimental magnesium precipitation rate results.

### DETAILED DESCRIPTION

Methods of production of alkaline calcium and/or magnesium solids derived from strong acid extraction of critical elements from geological materials are provided. Aspects of the methods combine strong acid leaching of geologic feedstocks with critical element separation and calcium and/or magnesium carbonate, hydroxycarbonate, and/or hydroxide precipitation. In addition, systems for practicing methods of embodiments of the invention are provided.

Before the present invention is described in greater detail, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrecited number may be a number which, in the context in which it is presented, provides the substantial equivalent of the specifically recited number.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, representative illustrative methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention. Any recited method can be carried out in the order of events recited or in any other order which is logically possible.

While the apparatus and method has or will be described for the sake of grammatical fluidity with functional explanations, it is to be expressly understood that the claims, unless expressly formulated under 35 U.S.C. § 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 U.S.C. § 112 are to be accorded full statutory equivalents under 35 U.S.C. § 112.

### Methods

As discussed above, aspects of the invention include methods of electrolytic upcycling of sulfate waste. Methods of interest include electrolyzing an aqueous sulfate to produce an acidic solution and a basic solution, extracting a mineral from a mineral source using the acidic solution, precipitating an inorganic alkaline solid formed from a sulfate waste product, thereby regenerating the aqueous sulfate, and recirculating the regenerated aqueous sulfate for electrolysis. In some cases, the electrolytic protocols of the invention provide economic, environmental, and/or strategic co-benefits for the precipitation of inorganic alkaline solids. For example, methods of the invention may be employed to reduce the amount of sulfate wastes that are produced as a result of industrial processes, or reduce existing stockpiles of sulfate wastes, such as by 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more such as 80% or more, such as 85% or more, such as 90% or more such as 95% or more, and including by 100%. The methods described herein may also be employed to enhance carbon dioxide reduction. For example, in some embodiments, use of the subject methods for mineral extraction may reduce carbon dioxide emissions related to the extraction as compared to conventional methods by 20% or more, such as 25% or more, such as 30% or more, such as 35% or more, such as 40% or more, such as 45% or more, such as 50% or more, such as 55% or more, such as 60% or more, such as 65% or more, such as 70% or more, such as 75% or more such as 80% or more, such as 85% or more, such as 90% or more such as 95% or more, and including by 100% or more.

Protocols used for electrolyzing the aqueous sulfate may vary. “Electrolysis” and “electrolyzing” are referred to in their conventional sense to describe a chemical reaction that is driven by an electric current. In embodiments, the electrolysis reaction proceeds as follows:

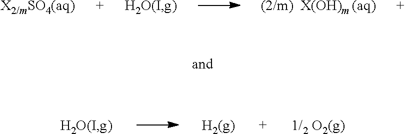

where X is a suitable counterion with charge m. Counterions may include, but are not limited to, K⁺, Ca²⁺, Na⁺, Li⁺, NH₄⁺ and Mg²⁺. Remaining water, hydrogen ions (H⁺), and sulfate ions (SO₄²⁻) comprise a sulfuric acid solution. In addition, hydrogen (H₂) and oxygen (O₂) gasses may be evolved. Electrolytic protocols for use in the subject methods may vary. While the current applied to an electrolyzer in embodiments of the invention may vary, in some instances the applied current ranges from 10 mA/cm² to 1,000 mA/cm², such as 60 to 600 mA/cm², and including 150 to 300 mA/cm². In addition, the cell voltage at which the electrolyzing occurs may vary. In some embodiments, the electrolyzing occurs at a cell voltage ranging from 1 V to 15 V, such as 2 V to 10 V, and including 3 V to 7 V. Electrolytic protocols may have any convenient source of electricity. In some instances, the source of electricity for the process is a low-carbon energy source generated by solar, wind, hydroelectric, geothermal, hydrogen, nuclear, or fusion power plants, with or without battery energy storage, that can optionally be purchased from the electrical grid.

Any suitable aqueous sulfate may be electrolyzed in the present methods. In some cases, the aqueous sulfate may be sodium sulfate (Na₂SO₄), potassium sulfate (K₂SO₄), calcium sulfate (CaSO₄), lithium sulfate (Li₂SO₄), magnesium sulfate (MgSO₄), ammonium sulfate ((NH₄)₂SO₄), and the like, or combinations thereof. The aqueous sulfate may have any convenient source. In some cases, the aqueous sulfate is produced via methods of the invention. For example, as described in further detail below, methods of the invention include precipitating an inorganic alkaline solid formed from a sulfate waste product, and thereby regenerating an aqueous sulfate. The regenerated aqueous sulfate may subsequently be electrolyzed.

As discussed above, electrolysis of the aqueous sulfate via the subject methods produces an acidic solution and a basic solution. The acidic solution produced in the electrolytic protocol can include, but is not limited to, sulfuric acid (H₂SO₄), hydrochloric acid (HCl) and hydrofluoric acid (HF), and the like, or combinations thereof. In some embodiments, the acidic solution comprises H₂SO₄. In additional embodiments, the acidic solution comprises HF. In other embodiment, the acidic solution comprises HCl. The basic solution may likewise vary. In some embodiments, the basic solution is an alkaline solution. Basic solutions of interest may include, but are not limited to, sodium hydroxide (NaOH), potassium hydroxide (KOH), and magnesium hydroxide (Mg(OH)₂). In select cases, the basic solution comprises NaOH. In additional cases, the basic solution comprises KOH. In still additional cases, the basic solution includes magnesium hydroxide (Mg(OH)₂). In yet additional cases, the basic solution comprises ammonia (NH₃).

Electrolytic protocols of the invention include the use of an electrolyzer stack of one or more electrochemical cells. The number of electrochemical cells may vary, and can range from, e.g., 1 to 60, such as 2 to 20. Each electrochemical cell may include an anode within an anode chamber containing an anolyte, a cathode within a cathode chamber containing a catholyte, and a cation exchange membrane separating the anode and cathode chambers. In some embodiments, the anode is an acid-resistant anode (e.g., consisting of titanium, platinized titanium, carbon, or other conductive support). In embodiments, the anode includes catalyst for water oxidation (e.g., platinum, iridium oxide, mixed metal oxide or other catalyst suitable for water oxidation) deposited on the anode. In other embodiments, the anode includes catalyst for hydrogen (H₂) oxidation. In some cases, the cathode includes porous titanium, stainless steel, or other material suitable for water reduction.

The anolyte within the anode chamber may vary. In certain cases, the anolyte comprises water. In some cases, the anolyte comprises the aqueous sulfate. In select cases, the anolyte (e.g., comprising the aqueous sulfate) is recirculated. Similarly, the catholyte within the cathode chamber may vary. In some cases, the catholyte comprises water. In select versions, the catholyte comprises the aqueous sulfate. In certain instances, methods include recirculating the catholyte.

Electrochemical cells for use in methods of the invention include a cation exchange membrane (CEM). As is understood in the electrochemical arts, cation exchange membranes, which primarily consist of negatively charged groups (anions), prevent anions from passing through the membrane while allowing positively charged groups (cations) to pass through. The CEM may be the only ion exchange membrane in each electrochemical cell, or it may be employed in conjunction with other membranes (e.g., anion exchange membranes, bipolar membranes and/or additional cation exchange membranes). In some cases, the cation exchange membrane is configured so that sodium cation (Na⁺) crosses the cation exchange membrane to the cathode chamber. In some such embodiments, the aqueous sulfate—in this example, Na₂SO₄—is provided to the anode chamber and, during electrolysis, Na⁺ is drawn through the CEM into the cathode chamber. However, it is understood that where other aqueous sulfates are employed, the CEM is configured so that other cations cross the CEM into the cathode chamber. For example, the CEM could be configured to pass K⁺, Ca²⁺, Li⁺, NH₄⁺ and Mg²⁺, and the like, depending on the type of aqueous sulfate employed. In the example where aqueous Na₂SO₄ is electrolyzed, the Na₂SO₄ is converted to an acid solution by water oxidation (i.e., sulfuric acid (H₂SO₄)), as follows:

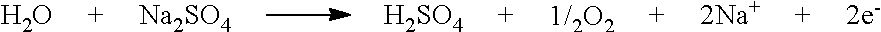

In the cathode chamber, water reduction occurs, as follows:

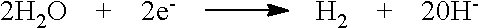

The Na⁺ ions crossing the CEM into the cathode chamber form sodium hydroxide (NaOH), as follows:

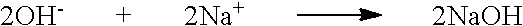

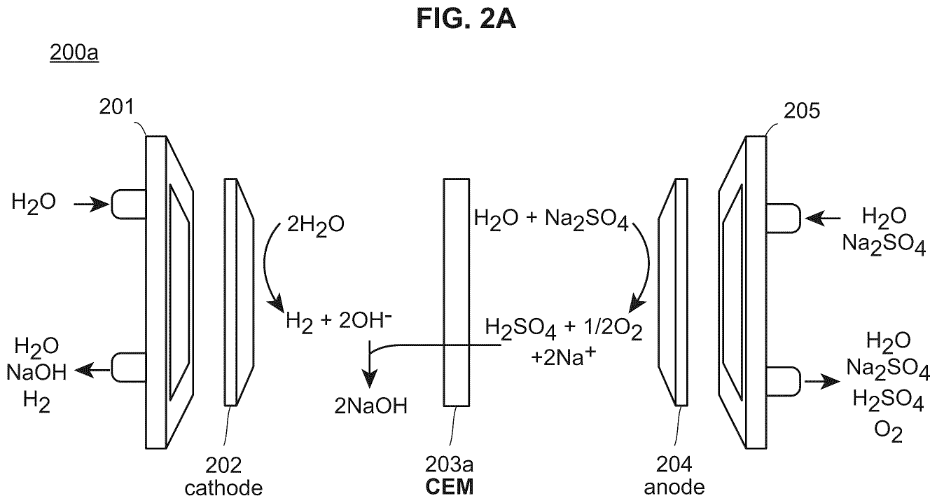

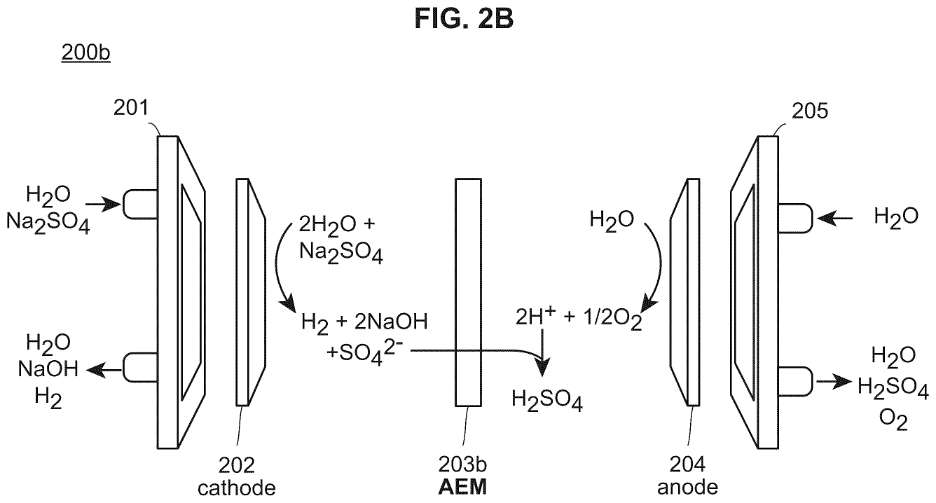

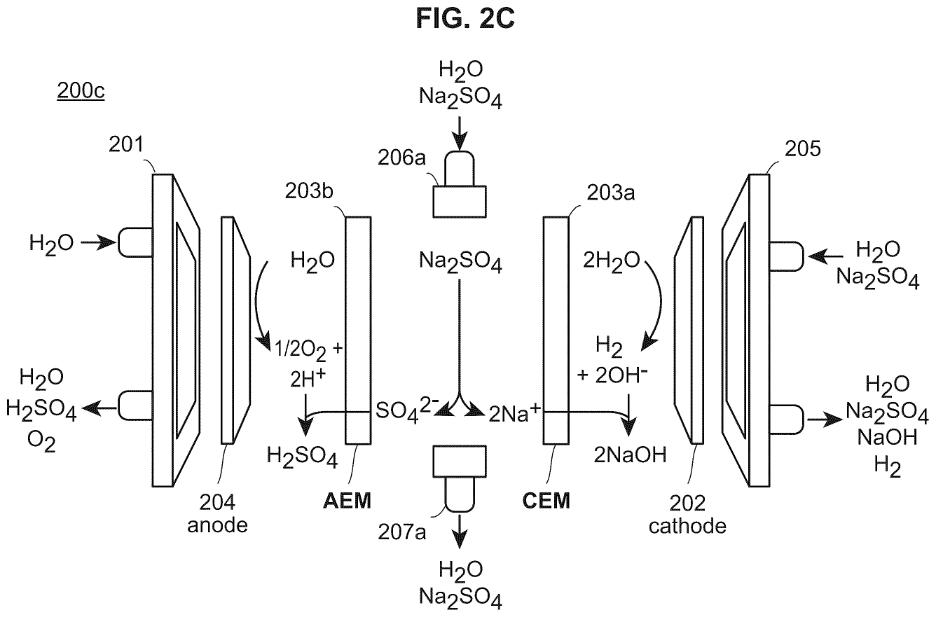

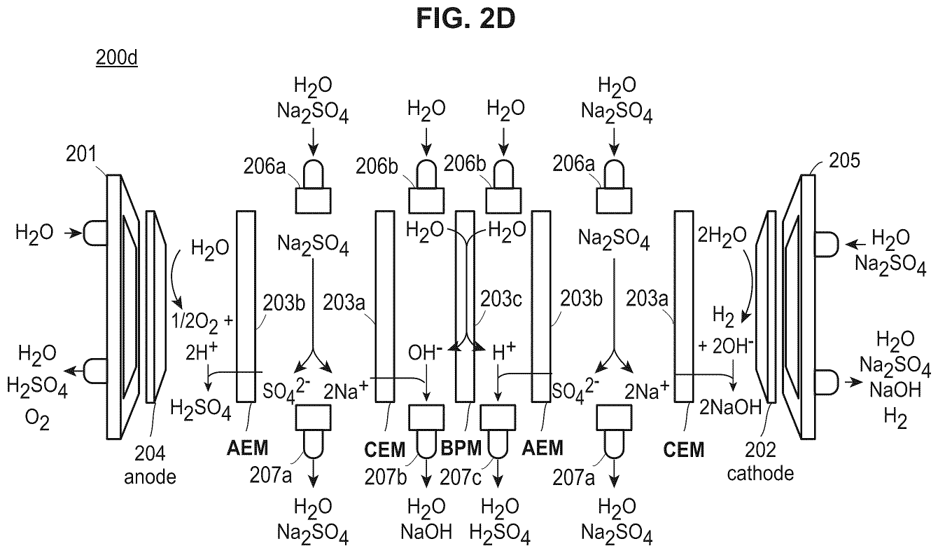

An exemplary electrochemical cell comprising a CEM is shown in FIG. 2A, described in greater detail below. As shown above, CEM-based electrochemical cells produce hydrogen (H₂) in equi-molar quantity to the acid (e.g., H₂SO₄) and two moles of base (e.g., 2NaOH) produced, but with a higher current efficiency (up to 95-100%) with respect to H₂ production than acid and/or base production due to lower Faradaic losses of the produced gasses compared to the produced acid and base.

In embodiments, methods of the invention involving electrochemical cells that are CEM-separated include producing a concentrated basic solution. In other words, methods include concentrating the basic solution. In some such embodiments, the concentration of the concentrated basic solution ranges from 0.1 M to 3 M, such as 0.1 M to 1.5 M, and including 0.5 M to 2 M. The pH of the concentrated basic solution may likewise vary, in some cases ranging from 12 to 15, such as 13 to 14.5, such as 13.5 to 14.4, and including 13.7 to 14.3. In certain embodiments, CEM electrolysis produces dilute acid at concentrations between 0.05-1 M and concentrated hydroxide solutions at concentrations between 0.5-2.0 M with production of hydrogen and oxygen. Methods may or may not include producing concentrated acidic or basic solutions that include a substantial amount of salt. For example, salt (e.g., Na₂SO₄) may exist in amounts ranging ppm-level (e.g., 1 ppm to 1 million ppm) to saturation. In some embodiments, concentrating the basic solution comprises recirculating it through the electrolytic cell(s). In other embodiments, acidic and basic solutions are recirculated through the electrolytic cell(s) at steady-state concentration.

In addition to a CEM, some embodiments of the invention also include one or more anion exchange membranes (AEMs). As is understood in the electrochemical arts, AEMs, which primarily consist of positively charged groups (cations), prevent cations from passing through the membrane while allowing negatively charged groups (anions) to pass through. In some embodiments, the AEM is configured so that sulfate anion (SO₄²⁻) crosses the anion exchange membrane. During electrolysis, base is formed and sulfate ion crosses the AEM to form an acidic solution comprising H₂SO₄. Although it should be realized that other aqueous sulfates may be employed as noted above, one example in which the aqueous sulfate is Na₂SO₄ will be discussed. During electrolysis, the following water reduction reaction occurs in the cathode chamber:

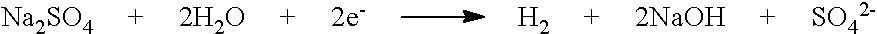

Water oxidation occurs on the other side of the AEM in the anode chamber:

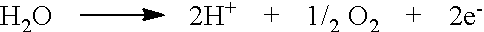

Sulfate ion crosses the AEM from the cathode chamber to the anode chamber, at which point an acidic solution is formed, as follows:

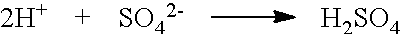

FIG. 2B depicts the operation of an electrochemical cell comprising an AEM, for illustrative purposes.

In a given electrochemical cell, the number of CEMs may range from 1 to 4, such as 2 to 3. In some embodiments, one or more electrochemical cells includes 1 CEM. In other embodiments, one or more electrochemical cells includes 2 CEMs. Similarly, in a given electrochemical cell, the number of AEMs may range from 0 to 4. In certain embodiments, electrochemical cells do not include an AEM. In other embodiments, electrochemical cells include 1 AEM. In still other embodiments, electrochemical cells include 2 AEMs. In a certain embodiment, one or more electrochemical cells includes one AEM and one CEM. The electrochemical cells may include more than two chambers. In some cases, the number of chambers ranges from 2 to 6, such as 3 to 4. In select cases, one or more electrochemical cells includes 3 chambers (i.e., an anode chamber, a cathode chamber, and a third (i.e., middle) chamber separating the anode and cathode chambers). In some such cases, electrolyzers include a cell or stack of cells comprised of an anode compartment separated from the sulfate feed solution compartment by an AEM as well as a cathode compartment separated from the sulfate feed solution compartment by a CEM. In other cases, electrolyzers include a cell or stack of cells comprised of an anode compartment separated from the sulfate feed solution compartment by an CEM as well as a cathode compartment separated from the sulfate feed solution compartment by a AEM. In additional instances, one or more electrochemical cells include 5 chambers (i.e., an anode chamber, a cathode chamber and three additional chambers separating the anode and cathode chambers). An example of electrolysis using three chambers is shown in FIG. 2C, described in further detail below.

In some embodiments, methods of the invention include bipolar membrane electrodialysis (BMED). As is understood in the art, bipolar membranes (BPMs) are ion-exchange membranes having a cation- and an anion-exchange layer. This allows the generation of protons and hydroxide ions via water dissociation. Additional details regarding BPMs may be found in, for example, U.S. Pat. Nos. 4,024,043; 4,057,481; 4,116,889; 4,766,161; 5,207,879; 5,221,455; 5,288,385; 5,401,408; 6,217,733; 8,535,502; 8,980,070; and 10,833,347; the disclosures of which are herein incorporated by reference in their entirety. An example of BMED is shown in FIG. 2D, described in greater detail below.

In some embodiments involving electrolysis in an electrochemical cell comprising three or more chambers (with or without a BPM), methods include producing both a concentrated acidic solution and a concentrated basic solution. For example, the concentration of the acidic solution may be 0.1 M or greater, and the solution may have a pH ranging from −1 to 1. The concentration of the basic solution may range from 0.5 M to 2 M, and the solution may have a pH ranging from 13.7 to 14.3. Electrolysis may occur, in some cases, at a range of current efficiencies between 90%-100% with respect to H₂ and 20-95% with respect to H₂SO₄ and 80-100% with respect to NaOH. In some cases, three-compartment electrolysis produces concentrated acid solutions at concentrations between 0.05 M to >2.0 M and concentrated hydroxide solutions at concentrations between 0.5 M to 2.0 M with production of hydrogen and oxygen. In additional embodiments, BMED electrolysis produces concentrated acid solutions at concentrations between 0.05 M to >2.0 M and concentrated hydroxide solutions at concentrations between 0.5-2.0 M.

Methods may include maintaining a low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1,000 L/min for a 1 metric ton CO₂ mineralization per day.

In addition, methods according to some embodiments may include generating an acid concentration in the anolyte that is higher than the base concentration in the catholyte even though protons and hydroxides are produced at the same rate in the electrochemical cell where in some instances the magnitude of the acid to base concentration ratio ranges from 5 to 100,000, such as 10 to 100. In addition, methods may include recirculating water at a constant rate through the anode chamber to allow for accumulation of sulfuric acid, e.g., at a total stack flow rate ranging in some instances from 15 to 100 L/min, such as 60 to 90 L/min and including 10 to 300 L/min for a 1 metric ton CO₂ mineralization per day system.

In embodiments, methods include maintaining a relatively low concentration of base (OH⁻) in the catholyte or center compartment relative to the concentration of acid (H⁺) in the anolyte by recirculating fluid from mineralization through the cathode chamber and center compartment rather than using the same solution feeds into all chambers, such that although protons and hydroxides are produced at the same rate in the electrochemical cell, the system generates an acid concentration in the anolyte that is much higher than (by at least about 5 times to about 200,000 times) the base concentration in the catholyte or the center compartment, because the fluids are circulated separately, which (i) minimizes Faradaic losses by migration of OH⁻ across the anion exchange membrane and resulting loss reaction: OH⁻+H⁺→H₂O in the electrochemical cell and (ii) protects the anion exchange membrane from degradation in strong base.

Aspects of the subject methods additionally include extracting a mineral from a mineral source using the acidic solution produced during the electrolysis. In some embodiments, the extracted mineral is a “critical” mineral, i.e., minerals that are important to the economy and/or national security. Critical minerals that may be extracted include, but are not limited to, aluminum (bauxite), antimony (Sb), arsenic (As), barium (Ba), beryllium (Be), bismuth (Bi), cesium (Cs), chromium (Cr), cobalt (Co), copper (Cu), fluorspar (CaF₂), gallium (Ga), germanium (Ge), phosphorus (P), hafnium (Hf), indium (In), lithium (Li), magnesium (Mg), manganese (Mn), niobium (Nb), platinum group metals (PGM), potash, the rare earth elements group, rhenium (Re), rubidium (Rb), scandium (Sc), strontium (Sr), tantalum (Ta), tellurium (Te), tin (Sn), titanium (Ti), tungsten (W), uranium (U), vanadium (V), and zirconium (Zr), as well as combinations/alloys thereof. In certain cases, the extracted mineral includes a rare earth element, including but not limited to lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Th), yterrbium (Yb), lutetium (Lu), and the transition elements scandium (Sc) and yttrium (Y), as well as combinations thereof. In select cases, the extracted mineral is selected from a group consisting of lithium (Li), iron (Fe), cobalt (Co), and the platinum group metals (PGM). In select cases, the extracted mineral comprises phosphorus (P).

In some cases, the extracted mineral is a silicate. In some such cases, the extracted mineral is a mafic mineral. For example, the extracted mineral may be selected from olivine ((Mg,Fe)₂SiO₄), pyroxene (XY(Si,Al)₂O₆, where X is Ca, Na, Fe II, Mg, Zn, Mn or Li; and Y is Cr, Al, Mg, Co, Mn, Sc, Ti, V, Fe II or Fe Ill), serpentine, amphibole and biotite (K(Mg,Fe)₃AlSi₃O₁₀(F,OH)₂), or combinations thereof. Where the extracted mineral includes amphibole, the amphibole may be an iron-magnesium amphibole, a calcic amphibole, a sodic-calcic amphibole, or a sodic amphibole. In select cases, the amphibole is selected from holmquistite (Li₂Mg₃Al₂Si₈O₂₂(OH)₂), pargasite (NaCa₂(Mg₄Al)(Si₆Al₂)O₂₂(OH)₂), winchite ((CaNa)Mg₄(Al,Fe³⁺)Si₈O₂₂(OH)₂), and edenite (NaCa₂Mg₅(Si₇Al)O₂₂(OH)₂). In some cases, the extracted mineral is an ultramafic mineral or hydrothermal alteration product. In some such cases, the extracted material includes dunites, serpentinites, peridotites, pyroxenites, and/or troctolite.

The technique employed to extract the mineral may vary. In some embodiments, methods include extracting the mineral via an acid leaching protocol. In some instances, the acid leaching protocol is a sulfuric acid leaching protocol, although leaching via other acids (e.g., HCl, HF, H₃PO₄) instead of or in addition to sulfuric acid is envisioned. In acid leaching, a mineral source (e.g., ore, mine tailings, etc.) may be combined with acid under conditions of ambient or elevated temperature and pressure to convert the minerals within the ore into soluble salts. In embodiments, acid leaching occurs in a hydraulically restricted pile known as a heap leach. In other embodiments, acid leaching occurs as a countercurrent leach in several steps, such as 2-5 steps, where fresh acid is added to previously leached material and fresh material is added to previously leached acid. In still other embodiments, acid leaching occurs within an autoclave. Pressures that may be used can vary and include, e.g., 0.2 MPa or more, 0.3 MPa or more, 0.4 MPa or more, 0.5 MPa or more, 0.6 MPa or more, 7 MPa or more, 8 MPa or more, and including 9 MPa or more. Temperatures that may be used range from, e.g., 400 K to 600 K, such as 410 K to 590 K, such as 420 K to 580 K, such as 430 K to 570 K, such as 440 K to 560 K, such as 450 K to 550 K, such as 460 K to 540 K, and including 470 K to 530 K. Acid leaching is described in further detail in, for example, U.S. Pat. Nos. 3,087,809; 3,741,752; 3,773,891; 3,809,549; 3,880,981; 4,410,498; 4,098,870; 4,872,909; 6,383,255; 6,406,676; 6,471,743; 7,387,767; 8,025,859; 9,732,400; and 10,808,296; the disclosures of which are incorporated by reference herein in their entirety.

The extracted mineral may be obtained from any suitable mineral source. In some cases, the mineral source is a byproduct of another process. For example, in select versions, the mineral source is comprised of mine tailings. In other embodiments, the mineral source is an ore. The mineral content of the mineral source (i.e. the percentage of the mineral of interest relative to other components of the mineral source) may vary, and in some cases may be 0.1% or more, such as 0.5% or more, such as 1% or more, such as 5% or more, such as 10% or more, such as 15% or more, such as 20% or more, such as 25% or more, such as 30% or more, such as 35% or more, and including 40% or more. In some instances, methods include pulverizing the mineral source prior to extraction. In certain instances, the mineral source is rock phosphorus, sometimes referred to as phosphorite, phosphate rock or rock phosphate. In some cases, the mineral source comprises fluorapatite (Ca₅(PO₄)₃F) and/or hydroxyapatite (Ca₅(PO₄)₃OH or Ca₁₀(PO₄)₆(OH)₂). In certain instances, the mineral source is a silicate mineral source (i.e., comprising silicon and oxygen).

Extraction of the mineral according to aspects of the present methods includes producing a sulfate waste product. The sulfate waste product may vary in different embodiments of the invention. The sulfate waste can include, but is not limited to, calcium sulfate (CaSO₄) or hydrates thereof, as well as magnesium sulfate (MgSO₄) or hydrates thereof. In some cases, the sulfate waste product comprises magnesium sulfate (MgSO₄). In a certain example, the sulfate waste product is MgSO₄·7H₂O. In certain instances, the sulfate waste product comprises phosphogypsum (CaSO₄·2H₂O). Phosphogypsum is discussed herein in its conventional sense to describe the calcium sulfate of varied hydration states generally formed as a byproduct of phosphoric acid production protocols. Such protocols often involve the use of sulfuric acid (H₂SO₄) in treating phosphate ore. In some cases, the generation of phosphogypsum proceeds as follows:

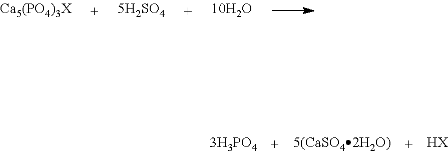

The “X” in the above reaction may, in some cases, be F⁻, OH⁻, Br⁻, or Cl⁻. Phosphogypsum may also include one or more of the following: SiO₂, Cd, Al, Ba, Pb, Cr, Se, U, Fe, P, Th, Ra, and Rare Earth Elements (REEs). Phosphoric acid (H₃PO₄), produced in the above-described reaction, is often applied in phosphate fertilizer production. In some cases, phosphogypsum used in the subject methods is a result of sulfuric acid reaction with rock phosphorus in fertilizer production. Phosphate fertilizers of interest include, e.g., diammonium phosphate (DAP), monoammonium phosphate (MAP), and triple super phosphate (TSP). Phosphate fertilizer production is described in, e.g., U.S. Pat. Nos. 3,856,500; 3,956,464; 4,321,078; 5,433,766; 6,322,607; 7,497,891; 8,506,670; and 9,764,993; the disclosures of which are incorporated by reference herein in their entirety.

In some embodiments, methods include reacting the basic solution with a CO₂ containing gas to form an aqueous carbonate. In some cases the basic solution may consist of an aqueous solution of cations such as sodium (Na⁺), potassium (K⁺), ammonium (NH₄⁺), and/or lithium (Li⁺), and in some cases the basic solution may contain alkaline anions including hydroxide (OH⁻), carbonate (CO₃²⁻), bicarbonate (HCO₃⁻), and/or phosphate (PO₄³⁻), with or without electrolyte anions such as chloride (Cl), sulfate (SO₄²⁻), and/or nitrate (NO₃⁻). CO₂ containing gas for use in the subject methods may be obtained from any convenient source. The CO₂ containing gas may be pure CO₂ or be combined with one or more other gasses and/or particulate components, depending upon the source, e.g., it may be a multi-component gas (i.e., a multi-component gaseous stream). While the amount of CO₂ in such gasses may vary, in some instances the CO₂ containing gasses have a pCO₂ of 10³ or higher, such as 10⁴ Pa or higher, such as 10⁵ Pa or higher, including 10⁶ Pa or higher. The amount of CO₂ in the CO₂ containing gas, in some instances, may be 20,000 or greater, e.g., 50,000 ppm or greater, such as 100,000 ppm or greater, including 150,000 ppm or greater, e.g., 500,000 ppm or greater, 750,000 ppm or greater, 900,000 ppm or greater, up to including 1,000,000 ppm or greater (In pure CO₂ exhaust the concentration is 1,000,000 ppm) In some instances may range from 10,000 to 500,000 ppm, such as 50,000 to 250,000 ppm, including 100,000 to 150,000 ppm. The temperature of the CO₂ containing gas may also vary, ranging in some instances from 0 to 1800° C., such as 100 to 1200° C. and including 600 to 700° C.

In some instances, the CO₂ containing gasses are not pure CO₂, in that they contain one or more additional gasses and/or trace elements. Additional gasses that may be present in the CO₂ containing gas include, but are not limited to water, nitrogen, mononitrogen oxides, e.g., NO, NO₂, and NO₃, oxygen, HF and other volatile fluoride compounds, sulfur, monosulfur oxides, (e.g., SO, SO₂ and SO₃), volatile organic compounds, e.g., benzo(a)pyrene C₂OH₁₂, benzo(g,h,l)perylene C₂₂H₁₂, dibenzo(a,h)anthracene C₂₂H₁₄, etc. Particulate components that may be present in the CO₂ containing gas include, but are not limited to particles of solids or liquids suspended in the gas, e.g., heavy metals such as strontium, barium, mercury, thallium, etc.

In certain embodiments, CO₂ containing gasses are obtained from an industrial plant, e.g., where the CO₂ containing gas is a waste feed from an industrial plant. Industrial plants from which the CO₂ containing gas may be obtained, e.g., as a waste feed from the industrial plant, may vary. Industrial plants of interest include, but are not limited to, power plants and industrial product manufacturing plants, such as but not limited to chemical, fertilizer, biofuel, and mechanical processing plants, refineries, cement plants, steel plants, etc., as well as other industrial plants that produce CO₂ as a byproduct of fuel combustion or other processing step (such as calcination by a cement plant or CO₂ off gassing by a phosphoric acid plant). Waste feeds of interest include gaseous streams that are produced by an industrial plant, for example as a secondary or incidental product, of a process carried out by the industrial plant.

Of interest in certain embodiments are waste streams produced by industrial plants that combust fossil fuels, e.g., coal, oil, natural gas, as well as man-made fuel products of naturally occurring organic fuel deposits, such as but not limited to tar sands, heavy oil, oil shale, etc. In certain embodiments, power plants are pulverized coal power plants, supercritical coal power plants, mass burn coal power plants, fluidized bed coal power plants, gas or oil-fired boiler and steam turbine power plants, gas or oil-fired boiler simple cycle gas turbine power plants, and gas or oil-fired boiler combined cycle gas turbine power plants. Of interest in certain embodiments are waste streams produced by power plants that combust syngas, i.e., gas that is produced by the gasification of organic matter, e.g., coal, biomass, etc., where in certain embodiments such plants are integrated gasification combined cycle (IGCC) plants. Of interest in certain embodiments are waste streams produced by Heat Recovery Steam Generator (HRSG) plants. Waste streams of interest also include waste streams produced by cement plants. Cement plants whose waste streams may be employed in methods of the invention include both wet process and dry process plants, which plants may employ shaft kilns or rotary kilns, and may include pre-calciners. Each of these types of industrial plants may burn a single fuel, or may burn two or more fuels sequentially or simultaneously. A waste stream of interest is industrial plant exhaust gas, e.g., a flue gas. By “flue gas” is meant a gas that is obtained from the products of combustion from burning a fossil or biomass fuel that are then directed to the smokestack, also known as the flue of an industrial plant.

In some instances, the CO₂ sequestering protocol comprises direct air capture (DAC). DAC encompasses a class of technologies and methods capable of separating carbon dioxide CO₂ directly from ambient air. A DAC system of the invention may be any system that captures CO₂ directly from air and generates a product that includes CO₂ at a higher concentration than that of the air that is input into the DAC system or that generates dissolved aqueous carbonate solution. DAC systems are systems that extract CO₂ from the air using solid or aqueous media that binds to CO₂ but not to other atmospheric chemicals (such as nitrogen and oxygen). As air passes over the CO₂ binding medium, CO₂ “sticks” to the binding medium. DAC systems of interest include, but are not limited to: aqueous hydroxide-based systems and CO₂ sorbent/temperature swing based systems. In some instances, the DAC system is a hydroxide-based system, in which CO₂ is separated from air by contacting the air with an aqueous hydroxide liquid. Examples of hydroxide-based DAC systems include, but are not limited to, those described in PCT published application Nos. WO/2009/155539; WO/2010/022339; WO/2013/036859; and WO/2013/120024; the disclosures of which are herein incorporated by reference. Where hydroxide-based systems are employed, capture of CO₂ in an aqueous hydroxide may proceed as follows:

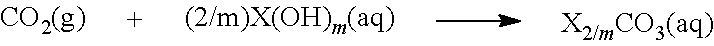

where X is a suitable counterion with charge m. In some cases, the method can use gases containing concentrated carbon dioxide by bubbling gas directly through a solution in which CaCO₃ precipitation is occurring using a disseminator or other suitable system to produce gas bubbles. In some cases, the DAC system can include an air contactor configured as a cooling tower, except the volumetric flux of air relative to that of hydroxide solution is approximately 50 times higher than standard cooling towers.

The present inventors have realized that basic/alkaline solutions having hydroxide concentrations of >0.5 M are suitable for direct air capture of carbon dioxide using an air contactor, and that electrochemical cells having CEMs are best configured to generate solutions having hydroxide at such concentrations. Such is shown below in Example 2. In other words, AEM-only electrolysis may be insufficient in some cases to produce the required hydroxide concentrations for DAC. In some cases, use of the basic solution of the disclosure increases the amount of carbon dioxide captured relative to non-CEM electrolytic protocols by 5% or more, such as 10% or more, such as 15% or more, such as 20% or more, such as 25% or more, such as 30% or more, such as 35% or more, such as 40% or more, such as 45% or more, and including 50% or more.

Methods of the invention additionally include precipitating an inorganic alkaline solid formed from the sulfate waste product. The inorganic alkaline solid may vary. In some embodiments, the inorganic alkaline solid is a carbonate solid. Carbonate solids of interest include, for example, calcium carbonate (CaCO₃), magnesium carbonate (MgCO₃), or sodium carbonate (Na₂CO₃) as well as hydrates thereof. In some instances, the inorganic alkaline solid product is a calcium hydroxide alkaline solid product, for example, calcium hydroxide (Ca(OH)₂). In select instances, the inorganic alkaline solid product is a magnesium hydroxide alkaline solid product. In such instances, the inorganic alkaline solid product comprises or is formed from magnesium hydroxide (Mg(OH)₂). In some embodiments, the inorganic alkaline solid is a magnesium hydroxy carbonate, such as a magnesium hydroxy carbonate having the formula of Mg₅(CO₃)₄(OH)₂·nH₂O. In some instances, the inorganic alkaline solid is artinite (Mg₂CO₃(OH)₂·3H₂O), hydromagnesite (Mg₅(CO₃)₄(OH)₂·4H₂O), or dypingite (Mg₅(CO₃)₄(OH)₂·5H₂O).

Where the inorganic alkaline solid is calcium carbonate, the inorganic alkaline solid is precipitated calcium carbonate (PCC). “PCC” is discussed herein in its conventional sense to refer to calcium carbonate (CaCO₃) that is produced via artificial or synthetic means. Put another way, PCC described in the instant disclosure is distinct from natural ground calcium carbonate (GCC). For example, PCC is not limestone that had been produced by natural processes (e.g., mined). Additionally, PCC for use in embodiments of the invention may not constitute calcium carbonate that is a product of an organism, including but not limited to gastropod shells, eggshells, and shellfish skeletons. In some cases, the PCC employed in the invention is, at the time of its use, precipitated relatively recently with respect to the geologic time scale, such as 100 years ago or less, 90 years ago or less, 80 years ago or less, 70 years ago or less, 60 years ago or less, 50 years ago or fewer, 40 years ago or less, 30 years ago or less, 20 years ago or less, 10 years ago or less, 5 years ago or less, 1 year ago or less, 6 months ago or less, 3 months ago or less, 1 month ago or less, 15 days ago or less, 10 days ago or less, 5 days ago or less, 1 day ago or less, 10 hours ago or less, 5 hours ago or less, 1 hour ago or less, 30 minutes ago or less, 10 minutes ago or less, and including 5 minutes ago or less. The PCC may consist of any convenient form of calcium carbonate. In some instances, the PCC is in a form selected from calcite, aragonite, vaterite, and amorphous calcium carbonate, or combinations thereof. In some cases, PCC of the invention comprises calcite. In additional embodiments, PCC of the invention comprises aragonite. In still additional embodiments, PCC of the invention comprises vaterite. In still additional embodiments, PCC of the invention comprises amorphous calcium carbonate or a combination of crystalline and amorphous calcium carbonate. In some embodiments, the inorganic alkaline solid product is a calcium hydroxide alkaline solid product. In other words, the inorganic alkaline solid product comprises or is formed from calcium hydroxide (Ca(OH)₂). Precipitates according to some embodiments are selected from calcite, aragonite, vaterite, disordered dolomite, magnesite, lansfordite, nesquehonite, dypingite, hydromagnesite, as well as combinations thereof.

Protocols for precipitating the inorganic alkaline solid may vary. In some cases, methods include leaching the sulfate waste, and using the resulting leachate for precipitation. Precipitation may or may not also involve a separate metathesis step beforehand. For example, in some cases, methods include metathesis in one or more metathesis reactors, where said metathesis is sufficient to cause the exchange of ions between the sulfate waste and the aqueous carbonate. Residual material (e.g., calcium, magnesium) may subsequently be precipitated out of the aqueous sulfate stream from the metathesis in carbonate precipitators. In some cases, there is no bifurcation of metathesis and carbonate reactors, and precipitation occurs in the same set of precipitators. In some cases, methods include calcium sulfate leaching in place of the metathesis to supply aqueous calcium sulfate for precipitation.

Following precipitation, the inorganic alkaline solid product may be subjected to one or more further treatment steps. In some embodiments, methods include setting the inorganic alkaline solid product. The initial inorganic alkaline solid product composition can include not only compounds in the solid state, but also compounds in a liquid state, e.g., liquid water. “Setting” the initial inorganic alkaline solid product composition is used interchangeably with “drying” the solid composition and includes placing the solid composition in an environment such that there is evaporation of liquid from the solid composition. By removing a liquid from the solid composition, the chemical composition and thereby physical properties of the solid composition can be altered, e.g., a reduced volume of liquid can cause solutes dissolved in the liquid to transition to a solid state. For example, the initial inorganic alkaline solid product composition can be placed on a solid surface so that it is not in contact with another liquid, e.g., so that liquid from the solid composition can evaporate and the solid composition will not gain liquid from another liquid. In some cases, the composition is placed within a thickener configured to reduce the liquid content of the composition. Thickeners of interest have an inlet for receiving a slurry of the inorganic alkaline solid product composition and an outlet where processed inorganic alkaline solid product is output with a lower water content. Thickeners may operate by maintaining a fluidized bed of settled slurry particles that pass to a filter press for solid-liquid separation, with thickener overflow water returned to the process. Residual liquid may subsequently evaporate from solids exiting the filter press. In some cases, methods include ways of increasing the rate of evaporation, e.g., flowing a gas past the solid composition, applying a reduced gas pressure to the solid composition, increasing the temperature of the solid composition, or a combination thereof. Flowing the gas past the solid composition can be performed, for example, with a fan. A pump, e.g., a vacuum pump, can be employed to reduce the gas pressure, thereby increasing the rate of evaporation. The temperature of the solid composition can be increased, e.g., using an electric heater or a natural gas heater, to a temperature, such as ranging from 25° C. to 95° C., such as from 35° C. to 80° C. In embodiments, the setting can be done simply by air drying for 1-30 days or by drying with elevated temperature (for minutes—hours at 30-200° C.).

In some embodiments, methods include subjecting the inorganic alkaline solid composition to a separation process. The term “separation process” is used herein in its conventional sense to refer to the conversion of a mixture of chemical substances to a plurality of different products. As discussed above, products of the precipitation process include an inorganic alkaline solid and aqueous sulfate. In some cases, the separation process includes separating water from the inorganic alkaline solid. In additional cases, the separation process includes separating sulfate from the inorganic alkaline solid. In still additional cases, the separation process includes separating an aqueous sulfate from the inorganic alkaline solid. In select cases, the separation process involves the use of a filter press. Filter presses operate by injecting a slurry into one or more chambers. Pressure in the chambers is increased, and liquid is strained through a filter (e.g., using pressurized air or water). The type of filter press may vary. Examples include plate and frame filter presses, automatic filter presses, recessed plate filter presses, and membrane filter presses. Where aqueous sulfate is separated from the inorganic alkaline solid composition, the aqueous sulfate may in some versions be returned to the electrolysis step.

In the subject methods, precipitation of the inorganic alkaline solid product results in the regeneration of the aqueous sulfate. In an exemplary embodiment of the invention involving PCC, inorganic alkaline solid product precipitation and regeneration of the aqueous sulfate occurs, as follows:

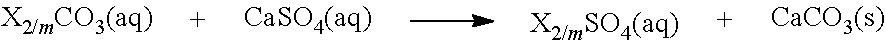

where X is a suitable counterion with charge m. While calcium-containing compounds (e.g., CaSO₄, CaCO₃) are shown in the reaction above, it is understood that other cations such as but not limited to magnesium or sodium may likewise be employed. While the source of carbonate may in some instances vary, methods according to some embodiments include receiving the carbonate (XCO₃) from the reaction of base with carbon dioxide (e.g., as discussed above) during a carbon capture process. Similarly, while the source of calcium sulfate (CaSO₄) may vary, the calcium sulfate may in some cases be from a gypsum source or a phosphogypsum source. In some instances, the source of calcium sulfate is phosphogypsum produced as a result of fertilizer production (e.g., discussed in detail herein).

Methods according to the subject disclosure also include recirculating the regenerated aqueous sulfate to the electrolyzer stack for electrolysis. The recirculation may be achieved by any suitable means. In some cases, the aqueous sulfate is recirculated to the electrolyzer stack via one or more pipes. In some cases, the recirculation is caused by one or more pumps. Depending on the configuration of the electrochemical cells, the aqueous sulfate may be supplied to one or more chambers (e.g., anode chamber, cathode chamber, additional chambers, etc.) of the electrochemical cells and gas-liquid separation may occur in a manifold.

In select embodiments, methods include treating the regenerated aqueous sulfate prior to recirculating it to the electrolyzer stack. In some cases, treatment of the regenerated aqueous sulfate includes removing one or more impurities from the regenerated aqueous sulfate. Some impurities, such as residual precipitate, have the potential to foul the electrochemical cells and are consequently removed. In some cases, treating the regenerated aqueous sulfate comprises passing the regenerated aqueous sulfate through a filter. Methods may also involve treating the aqueous sulfate in ion exchange columns. Suitable filters include, e.g., polishing filters that are configured to remove suspended solids. In some cases, methods additionally include separating water from the aqueous sulfate prior to recirculating it to the electrolyzer stack, such as by reverse osmosis (RO). Any suitable method of water separation (e.g., evaporation of water, etc.) may be employed. In embodiments, methods include concentrating the regenerated aqueous sulfate until it is at a concentration suitable for use in electrolysis. Suitable concentrations may range from 0.5 M to saturation.

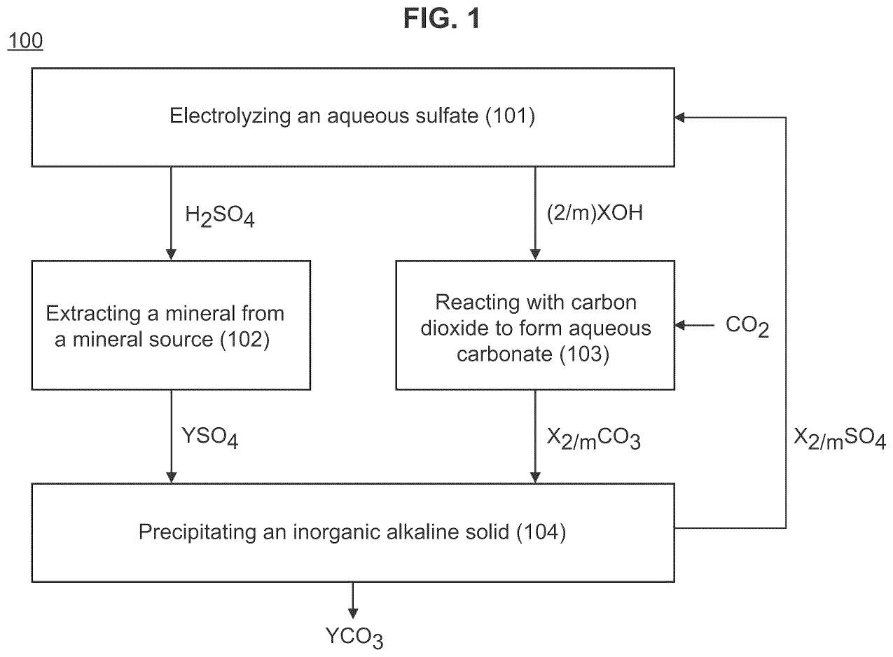

FIG. 1 presents a workflow for practicing an embodiment of the subject methods. As shown in FIG. 1, an aqueous sulfate is electrolyzed in step 101. As discussed above, the electrolysis occurs in an electrolyzer stack of one or more electrochemical cells comprising an anode within an anode chamber containing an anolyte, a cathode within a cathode chamber containing a catholyte, and a cation exchange membrane separating the anode and cathode chambers. Products of the electrolysis in step 101 include an acidic solution (in the embodiment of FIG. 1, H₂SO₄) and a basic solution (XOH; where X is a suitable counterion with charge m such as, but not limited to, Na⁺ or K⁺). The acidic solution from step 101 is subsequently employed in step 102 to extract a mineral from a mineral source (e.g., via acid leaching). The mineral extraction in step 102 results in a sulfate waste (YSO₄, where Y is a relevant counterion such as, but not limited to Ca²⁺ and Mg²⁺). In addition, the basic solution is used to react with carbon dioxide in step 103. This reaction forms an aqueous carbonate (X_{2/m}CO₃). In step 104, the sulfate waste and aqueous carbonate are employed in a metathesis/precipitation reaction, resulting in the precipitation of an inorganic alkaline solid (YCO₃) and the regeneration of the aqueous sulfate (X_{2/m}SO₄). Said regenerated aqueous sulfate is recirculated for use in step 101.

Products of the subject methods may have various uses. Uses of the extracted mineral may vary depending on mineral type. The minerals may be employed in, for example, catalysts, chemical reagents, electronics (e.g., cellular phones), jewelry, batteries, electric motors, fiber optic cables, solar panels, semiconductors, ceramic coatings, capacitors, and the like. In embodiments, the oxygen gas produced at the anode is off-gassed to the atmosphere, is collected to be compressed and sold, or is used as an oxidant in the sulfuric acid extraction process to avoid sulfate-reducing conditions. In addition, the hydrogen gas may be collected and employed, as desired. For example, synthesized H₂ may be employed, e.g., as fuel source, e.g., for transportation, power production, ammonia production, etc. For example, the synthesized H₂ may be employed in a hydrogen fuel cell, e.g., in an automobile. In additional instances, synthesized H₂ may be employed as a hydrogen feedstock for chemical synthesis. In other instances, synthesized H₂ may be returned to the anode compartment and oxidized at the anode to produce acid. In some embodiments, methods include storing the synthesized H₂, e.g., for later use. In some such embodiments, the synthesized H₂ is stored as a gas. For example, gaseous H₂ may be stored under pressure (e.g., 5,000-10,000 psi) in a gas tank. In some cases, methods include storing H₂ as a liquid (e.g., under cryogenic temperatures such as −253° C.).

The acidic solution (e.g., sulfuric acid) produced as described above may find multiple uses. As described above, sulfuric acid is often employed in phosphate fertilizer production. As such, embodiments of the invention include employing the produced sulfuric acid in phosphate fertilizer production. In some embodiments, methods include concentrating the produced acidic solution, e.g., prior to employing it for phosphate fertilizer production. Methods of acidic solution concentration may vary. In some cases, concentrating the acidic solution comprises mechanical vapor recompression. In other cases, concentrating the acidic solution comprises multi-effect evaporation. Acidic solution concentration may include one or more steps/stages. For example, in some cases, concentrating the acidic solution comprises a number of stages ranging from 1 to 3. When concentrated, the concentration of the sulfuric acid may be, for example, 0.5 M or more, such as 0.6 M or more, such as 0.7 M or more, such as 0.8 M or more, such as 0.9 M or more, such as 1 M or more, such as 1.1 M or more, such as 1.2 M or more, such as 1.3 M or more, such as 1.4 M or more, and including 1.5 M or more. In some cases, methods include concentrating the acidic solution to a final concentration that is up to or including the azeotrope concentration, which in some instances is approximately 98.5 wt. % at 25° C. As noted above, a byproduct of phosphorous fertilizer production is phosphogypsum. Such phosphogypsum may then be used to create more PCC, and so on. In some cases, the sulfate is substantively recycled to reduce the accumulation of sulfate wastes during mining and fertilizer production.

The inorganic alkaline solid may also have various uses. In some cases where the inorganic alkaline solid is magnesium carbonate, said inorganic alkaline solid may be employed in, for example, drying agents, taxidermy, flooring, fireproofing, fire extinguishing compositions, laxatives, cosmetics, dusting powder, and toothpaste. In some cases where the inorganic alkaline solid includes magnesium hydroxide, said inorganic alkaline solid may be employed in, for example, antacids, laxatives, and as a food additive. In some cases where the inorganic alkaline solid includes precipitated calcium carbonate (PCC), said inorganic alkaline solid may be employed in, for example, iron purification, oil drilling fluids, sugar refining, chalk, paint, resin, ceramic glazes, antacids, calcium supplements, blended cements, and food additives. In certain cases, PCC may be used as a feedstock for lime (CaO) production. In some cases, said lime is employed in cement production. The production of lime from PCC is described in U.S. Provisional Patent Application No. 63/443,217; the disclosure of which is incorporated by reference herein in its entirety.

### Systems

As discussed above, aspects of the invention also include systems. Systems of interest include an electrolyzer configured to electrolyze an aqueous sulfate to produce an acidic solution and a basic solution, the electrolyzer comprising an electrolyzer stack of one or more electrochemical cells comprising an anode within an anode chamber containing an anolyte, a cathode within a cathode chamber containing a catholyte, and a cation exchange membrane separating the anode and cathode chambers. Systems also include a reactor configured to extract a mineral from a mineral source using the acidic solution, thereby producing a sulfate waste product, and a precipitator configured to precipitate an inorganic alkaline solid formed from the sulfate waste product, thereby regenerating the aqueous sulfate. The precipitator is fluidically connected to the electrolyzer stack such that the regenerated aqueous sulfate is recirculated to the electrolyzer stack for electrolysis.

In embodiments, electrolyzers include a stack of cation exchange membrane (CEM)-separated two-compartment water electrolysis and electrodialysis cells containing an anode for production of acid and oxygen and a cathode for production of base and hydrogen. In embodiments, some such systems are designed to produce both relatively concentrated acid and relatively concentrated base simultaneously at a range of current densities between 10 and 1000 mA/cm² and cell voltages between 3.5 and 6 V. In embodiments, CEM-separated systems of the invention are configured to produce relatively dilute sulfuric acid, and the produced acid contains a substantial quantity of recirculated salt, with salt concentrations >0.1 M and produced acid concentrations up to 0.5 M. The CEM-separated system may be configured to produce a relatively concentrated base that may or may not contain a substantial quantity of salt. The range of produced base concentrations includes 0.1 to >1.5 M, with salt concentrations ranging from ppm-level up to saturation with respect to a recirculated soluble sulfate salt such as Na₂SO₄. Being an electrolysis system, the CEM system produces gaseous hydrogen (H₂) in equi-molar quantity to the theoretical acid produced but with a higher current efficiency (up to 95-100%) due to lower Faradaic losses of the produced gasses compared to the produced acid and base.

The CEM system may be configured for use with a component that removes carbon dioxide from the air or from point sources and produces aqueous carbonate solutions such as Na₂CO₃, for example using an air contactor in the case of air or a gas disseminator in the case of more concentrated carbon dioxide point sources. Unlike an AEM-separated system, the high concentration of produced base in the CEM-separated system enables direct air capture of carbon dioxide, allowing the system to accomplish carbon dioxide direct air capture and geologically permanent sequestration of carbon dioxide in carbonate solid phases.

In systems where dilute sulfuric acid and concentrated base are produced, CEM electrolyzers may be configured to produce sulfuric acid at concentrations between 0.05-1 M and concentrated hydroxide solutions at concentrations between 0.5-2.0 M with production of hydrogen and oxygen. The concentrated hydroxide solution is suitable for direct air capture of carbon dioxide using an air contactor. The produced sulfuric acid can contain a substantial concentration of sodium sulfate salt, from 0.25 to 1 M, such as 0.25-0.5M, or 0.4-0.6M or >0.5M.

The carbonate or carbonate-free hydroxide solutions may be reacted with a stream containing metal sulfates (e.g., calcium and or magnesium sulfate as solids or aqueous solutions) to precipitate solid carbonate phases including but not limited to calcite, aragonite, vaterite, disordered dolomite, magnesite, lansfordite, nesquehonite, dypingite, and hydromagnesite. Alternatively, the CEM system is configured to use the entire base stream to produce hydroxide phases such as brucite, Mg(OH)₂, and/or portlandite, Ca(OH)₂ or aqueous sodium, magnesium, or calcium hydroxide solutions instead of solid carbonate phases. In all configurations, the CEM system integrates a water treatment step or steps designed to remove residual alkaline earth elements (especially Ca and Mg) as well as other trace impurities by liming with a portion of the produced base stream, by ion exchange, or by a combination of these and/or other brine treatment steps. The treated brine stream is returned to the water electrolyzer in a continuous fashion to enable continuous, integrated operation.

FIG. 2A presents a schematic diagram of an electrochemical cell 200a comprising a CEM. Cell 200a includes exchange elements 201 and 205 having inlets and outlets for conveying liquid (i.e., anolyte and catholyte, as appropriate) to and from the cathode chamber comprising cathode 202 and anode chamber comprising anode 204, respectively. Water (H₂O) is provided to the cathode chamber, while water, sodium hydroxide (NaOH) and hydrogen (H₂) are conveyed from the cathode chamber. In addition, water and sodium sulfate (Na₂SO₄) are provided to the anode chamber, while water, sodium sulfate, sulfuric acid (H₂SO₄) and oxygen (O₂) are conveyed from the anode chamber. CEM 203a is configured such that sodium ion (Na⁺) crosses into the cathode chamber and forms the basic solution comprising sodium hydroxide. In some embodiments, catholyte and/or anolyte may be recirculated.

In some cases, electrolyzers include an anion exchange membrane. Exemplary electrolysis protocols according to such embodiments may be found in International Application No. PCT/US2022/039829, filed on Aug. 9, 2022; herein incorporated by reference in its entirety. In certain cases, the anion exchange membrane is configured so that sulfate anion crosses the anion exchange membrane to the anode chamber where sulfuric acid is generated. Methods may include maintaining a low concentration of base (OH⁻) in the catholyte relative to the concentration of acid (H⁺) in the anolyte, where in some instances the magnitude of the H⁺:OH⁻ ratio ranges from 5 to 100,000, such as 10 to 100 and including 2 to 200,000, where the relatively lower concentration of base is provided by flowing the catholyte through the cathode chamber, e.g., as a total stack flow rate ranging in some instances from 300 to 10,000 liters per minute (L/min) such as 500 to 1,000 L/min for a 1 metric ton CO₂ mineralization per day system, e.g., by recirculating fluid from the reactor through the cathode chamber.

In embodiments, the systems avoid the usual pitfalls of electrochemical acid-base production by maintaining a low concentration of OH⁻ in the feed solution or catholyte contacting the AEM, such that the ratio of sulfate (SO₄²⁻) to hydroxide (OH⁻) in the feed solution or catholyte is greater than 10. This configuration ensures that the flux of sulfate ions across the anion exchange membrane (AEM) is greater than the flux of hydroxide ions, minimizing Faradaic losses and increasing energy efficiency. The precipitation of carbonate, hydroxide, and hydroxycarbonate minerals consumes alkalinity, so the concentration of produced sulfuric acid is greater than the concentration of hydroxide in the catholyte by a factor of 5 or greater. Suitable AEMs minimize voltage by allowing a sufficiently high sulfate flux, while limiting proton leakage, and are durable over the pH range 0-14.

In embodiments, systems are configured to maintain a relatively low concentration of base (OH⁻) in the catholyte (AEM system) or the sulfate feed solution (three-compartment and BMED systems) relative to the concentration of acid (H⁺) in the anolyte by recirculating fluid from mineralization through the cathode chamber (AEM system) or the cathode and sulfate feed solution chambers (three-compartment and BMED systems) rather than using the same solution feeds into the cathode and anode chambers, such that although protons and hydroxides are produced at the same rate in the electrochemical cell, the system generates an acid concentration in the anolyte that is much higher than (by at least about 5 times to about 200,000 times) the base concentration in the solution contacting the AEM, because the fluids are circulated separately. This configuration (i) minimizes Faradaic losses by migration of OH across the anion exchange membrane and resulting loss reaction: OH⁻+H⁺→H₂O in the electrochemical cell and (ii) protects the anion exchange membrane from degradation in strong base. In embodiments, methods also include sequestering carbon dioxide as mineralized carbonate, e.g., calcium carbonate, and produce sulfuric acid by reacting sulfate solids, e.g., calcium sulfate solids, with electrochemically produced hydroxide solution contacted with carbon dioxide directly from air or from a more concentrated source. In addition, methods may include recirculating water at a constant rate through the anode chamber to allow for accumulation of sulfuric acid, e.g., at a total stack flow rate ranging in some instances from 15 to 100 L/min, such as 60 to 90 L/min and including 10 to 300 L/min for a 1 metric ton CO₂ mineralization per day system.

FIG. 2B presents a schematic diagram of an electrochemical cell 200b comprising an AEM. Cell 200b includes exchange elements 201 and 205 having inlets and outlets for conveying liquid (i.e., anolyte and catholyte, as appropriate) to and from the cathode chamber comprising cathode 202 and anode chamber comprising anode 204, respectively. Water (H₂O) and sodium sulfate (Na₂SO₄) are provided to the cathode chamber, while water, sodium hydroxide (NaOH) and hydrogen (H₂) are conveyed from the cathode chamber. In addition, water is provided to the anode chamber, while water, sulfuric acid (H₂SO₄) and oxygen (O₂) are conveyed from the anode chamber. AEM 203b is configured such that sulfate ion (SO₄²⁻) crosses into the anode chamber and forms an acidic solution comprising sulfuric acid. In some embodiments, catholyte and/or anolyte may be recirculated.

In other embodiments, electrolyzers include a stack of three-compartment water electrolysis and electrodialysis cells containing a CEM, an AEM, an anode for production of acid and oxygen, and a cathode for production of base and hydrogen (also referred to as the three-compartment system). In certain embodiments, the three-compartment system is configured to produce concentrated acid solutions at concentrations between 0.05 to >2.0 M, such as 1 M, and concentrated hydroxide solutions at concentrations between 0.5 to 2.0 M, such as 1 M, with production of gaseous hydrogen and oxygen. Hydroxide solution concentrations >0.5 M are suitable for direct air capture of carbon dioxide using an air contactor. Embodiments include a cell or stack of cells consisting of an anode compartment separated from the sulfate feed solution compartment by an AEM as well as a cathode compartment separated from the sulfate feed solution compartment by a CEM. The systems configured to contain three-compartment electrolysis cells may be designed to produce both relatively concentrated acid and relatively concentrated base simultaneously at a range of current efficiencies between 80-100% with respect to NaOH production. In embodiments, all aspects of the systems are similar to the CEM system, except the produced acid is substantively salt-free (ppm range concentrations of recirculated salt).

FIG. 2C depicts a three-compartment electrochemical cell comprising an AEM and a CEM. Cell 200c includes exchange elements 201 and 205 having inlets and outlets for conveying liquid (i.e., anolyte and catholyte, as appropriate) to and from the anode chamber comprising anode 204 and cathode chamber comprising cathode 202, respectively. Water (H₂O) is provided to the anode chamber, while water, sulfuric acid (H₂SO₄) and oxygen (O₂) are conveyed from the anode chamber. In addition, water and sodium sulfate (Na₂SO₄) are provided to the cathode chamber, while water, sodium sulfate, sodium hydroxide (NaOH) and hydrogen (H₂) are conveyed from the cathode chamber. Cell 200c also includes inlet 206a and outlet 207a configured to pass aqueous sulfate through the cell. During electrolysis, sulfate ion (SO₄²⁻) passes through AEM 203b to form sulfuric acid in the anode chamber, while sodium ion (Na⁺) passes through CEM 203a to form sodium hydroxide in the cathode chamber. In some embodiments, catholyte and/or anolyte may be recirculated.

In still other cases, systems include a stack of bipolar membrane electrodialysis (BMED) cells containing an AEM, a CEM and a bipolar membrane, with a single anode and cathode per stack. The systems configured to contain a BMED may be designed to produce both relatively concentrated acid and relatively concentrated base simultaneously at a range of current efficiencies between 80-100%. In embodiments, all aspects of the systems are similar to the CEM system, except the produced acid and base are both substantively salt-free (ppm range concentrations of recirculated salt). Further, the salt splitting step does not produce gaseous hydrogen and oxygen in the BMED system.

FIG. 2D depicts a bipolar membrane electrodialysis cell according to certain embodiments of the invention. Cell 200d includes exchange elements 201 and 205 having inlets and outlets for conveying liquid (i.e., anolyte and catholyte, as appropriate) to and from the anode chamber comprising anode 204 and cathode chamber comprising cathode 202, respectively. Water (H₂O) is provided to the anode chamber, while water, sulfuric acid (H₂SO₄) and oxygen (O₂) are conveyed from the anode chamber. In addition, water and sodium sulfate (Na₂SO₄) are provided to the cathode chamber, while water, sodium sulfate, sodium hydroxide (NaOH) and hydrogen (H₂) are conveyed from the cathode chamber. Cell 200d also includes CEMs 203a and AEMs 203b, as well as inlets 206a and outlets 207a configured to pass aqueous sulfate through chambers of the cell. Also in cell 200d is bipolar membrane 203c as well as inlets 206b and outlets 207b configured to provide water to chambers of the cell, and convey acidic and basic solutions from the chambers. Outlet 207c is configured to convey aqueous sulfuric acid from cell 200d.

Any of the above electrochemical units may also contain additional components that serve to protect the ion exchange membranes and/or electrode components from degradation or that improve the current efficiency of the system by facilitating acid/base separation. Each salt splitting approach has a unique set of embodiments. In some cases, the system is configured to recirculate a soluble sulfate salt (e.g., Na₂SO₄, K₂SO₄, Li₂SO₄, (NH₄)₂SO₄, or other sulfate salt), at a concentration between 0.5 M and saturation, which serves the role of supplying a sufficient quantity of sulfate anion and a cation (e.g., Na⁺) to the electrochemical unit to enable efficient production of acid and base. In some cases, the electrochemical unit configured as a BMED system is designed to produce concentrated acid solutions at concentrations between 0.05 to >2.0 M and concentrated hydroxide solutions at concentrations between 0.5-2.0 M.

In some cases, the carbonate precipitation reactor comprises a CO₂ sequestering device, such as an air contactor. Any suitable air contactor may be employed. In some instances, the air contactor is a DAC system, such as a hydroxide-based DAC system. DAC systems include, but are not limited to, those described in PCT published application Nos. WO/2009/155539; WO/2010/022339; WO/2013/036859; and WO/2013/120024. In select cases, the air contactor operates by bubbling gas directly through the caustic solution using a disseminator or other suitable system to produce gas bubbles. The concentrated hydroxide solution described above is suitable for direct air capture of carbon dioxide using the air contactor.

As discussed above, systems also include a reactor configured to extract a mineral from a mineral source using the acidic solution, thereby producing a sulfate waste product. The reactor is operably connected to the electrolyzer (e.g., via one or more pipes) such that the acidic solution is received in the reactor from the electrolyzer. Any suitable reactor configured to combine a mineral source and an acidic solution under conditions sufficient to extract the mineral from the mineral source may be employed. In some versions, acid leaching occurs in a hydraulically restricted pile known as a heap leach. In other versions, acid leaching occurs as a countercurrent leach in several steps, such as 2-5 steps, where fresh acid is added to previously leached material and fresh material is added to previously leached acid until the acid is substantially neutralized. In other versions, acid leaching occurs as a co-current leach in several steps, such as 2-5 steps. In some cases, a split of the caustic stream may be used for multi-stage neutralization to selectively recover multiple hydrolysis products, including a mixed hydroxide product. In some cases, this product is enriched in cobalt and depleted in iron, aluminum, manganese, magnesium, and other impurities. In select versions, the reactor is or comprises an autoclave. In some instances, pressures that may be used in the subject reactors can vary and include, e.g., 0.2 MPa or more, 0.3 MPa or more, 0.4 MPa or more, 0.5 MPa or more, 0.6 MPa or more, 7 MPa or more, 8 MPa or more, and including 9 MPa or more. Temperatures that may be used in the subject reactors range from, e.g., 400 K to 600 K, such as 410 K to 590 K, such as 420 K to 580 K, such as 430 K to 570 K, such as 440 K to 560 K, such as 450 K to 550 K, such as 460 K to 540 K, and including 470 K to 530 K. Devices and protocols that may be adapted for use in the subject reactor are described in, for example, U.S. Pat. Nos. 3,087,809; 3,741,752; 3,773,891; 3,809,549; 3,880,981; 4,410,498; 4,098,870; 4,872,909; 6,383,255; 6,406,676; 6,471,743; 7,387,767; 8,025,859; 9,732,400; and 10,808,296; the disclosures of which are incorporated by reference herein in their entirety. Systems of the invention may also include a pulverizer or crusher configured to reduce mineral source to finer particles.

Systems of the invention also include one or more precipitators. Any device suitable for the precipitation of an inorganic alkaline solid may be employed as the subject precipitator. In some embodiments, the precipitator is operably connected to the reactor and a source of caustic solution or carbonate. The precipitator may introduce the reagents in any suitable manner (e.g., disintegration and/or spraying, etc.). In some cases, the precipitator is a continuous flow mixer. Precipitators may additionally an agitator configured to mix the slurry undergoing precipitation. Agitators of interest may include one or more sets of rotors and blades. Where multiple rotors are employed, embodiments of the precipitation reactor include rotors rotating in opposite directions or in the same directions at different speeds. The blades, or the like, can create shear forces, turbulence and under and overpressure pulses, which grind, or disintegrate and spray the material. Precipitators that may be adapted for use are described in, e.g., U.S. Pat. No. 8,012,445, the disclosure of which is incorporated by reference herein.

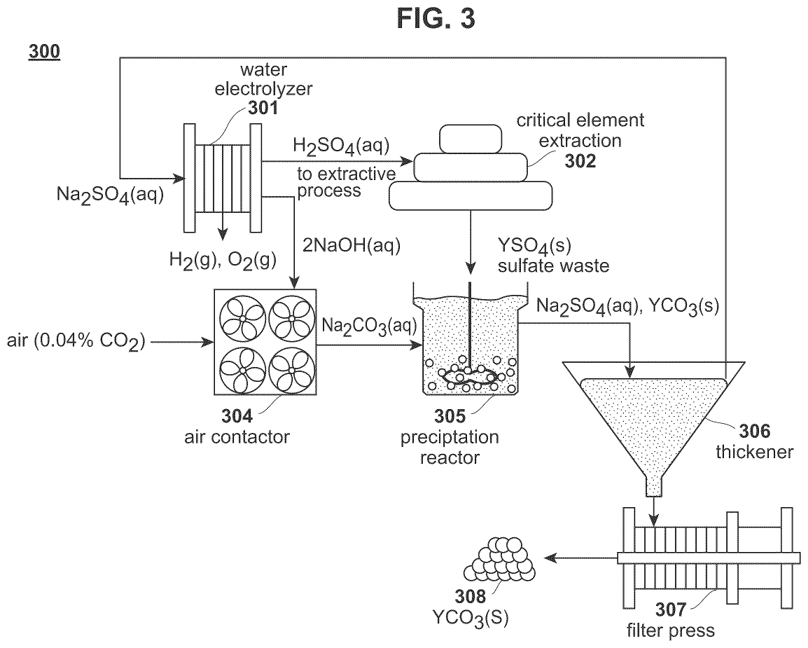

FIG. 3 is a schematic flow diagram of a system according to certain embodiments of the invention. System 300 includes an electrolyzer 301 configured to receive an aqueous sulfate (Na₂SO₄), and produce an acidic solution (H₂SO₄), oxygen (O₂), hydrogen (H₂) and a basic solution (NaOH). The hydrogen may be collected for future use. For example, the hydrogen could be used in a hydrogen fuel cell. Oxygen may be vented to the atmosphere, or likewise collected for use in any suitable application. The sulfuric acid may be used for critical element extraction in reactor 302, thereby producing a sulfate waste (YSO₄; where Y is a suitable cation). Air contactor 304 employs the basic solution from the electrolyzer 301 to capture gaseous CO₂, thereby producing an aqueous carbonate (Na₂CO₃). The precipitator 305 employs the aqueous carbonate and the sulfate waste in order to precipitate an inorganic alkaline solid (YCO₃), and regenerate the aqueous sulfate (Na₂SO₄). The products from the precipitator are received in thickener 306 configured to reduce the liquid content of the solid composition. Regenerated aqueous sulfate is recirculated to electrolyzer 301 for use in the electrolysis reaction. The inorganic alkaline solid is further processed in filter press 307 in order to generate final product 308.

Systems may additionally include one or more treatment components configured to treat the regenerated aqueous sulfate prior to its recirculation to the electrolyzer. Purification of the brine exiting the precipitation reactor may be included to prevent scaling and fouling of electrolyzer components. In addition or alternatively, the treatment components may be employed to selectively extract valuable elements or to remove other impurities from the aqueous solution, such that a purified sulfate brine such as sodium sulfate is produced. Treatment components that may be employed include, for example, filters (e.g., polishing filters) and ion exchange columns.

In the following sections, particular embodiments of the invention are described in greater detail:

### Systems for Calcium Sulfate Waste Upcycling to Sulfuric Acid and Carbon Mineralization

As discussed above, methods of the invention involve using solid calcium sulfate waste, such as waste derived from phosphoric acid production from rock phosphate, as a feedstock for electrolytic sulfuric acid, hydrogen, and precipitated calcium carbonate production. In embodiments of the invention, systems configured to carry out such methods include an electrolyzer configured to receive soluble sulfate salt solutions and produce separate sulfuric acid and base solution streams. Exemplary electrolyzers are described above with respect to FIG. 2A-2D. In embodiments, the system includes a carbon dioxide removal component configured to receive a portion of base solution from the electrolyzer and generate an aqueous carbonate and bicarbonate solution using carbon dioxide derived from a gaseous source such as air or an industrial point source. In some cases, the system is configured to carry out one or more calcium sulfate metathesis steps. In some such cases, systems are configured to receive solid calcium sulfate and the majority of (bi)carbonate solution from the carbon dioxide removal component and to precipitate solid calcium carbonate minerals, including a component that performs solid-liquid separation.

In an example, the invention includes a system designed to process phosphogypsum waste generated during phosphoric acid fertilizer production from rock phosphate to produce solid calcium carbonate, hydrogen, oxygen, sulfuric acid, with optional selective separation of critical elements and optional production of phosphogypsum residue. The overall chemical reaction for this example of the process, not including impurities, is:

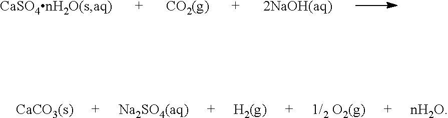

The electrochemical system is configured to include a three-compartment electrochemical cell stack and to receive carbon dioxide from the air using an air contactor, with or without additional carbon dioxide capture from a point source. Gypsum is introduced directly into the metathesis reactor using a suitable method, where it is converted to calcium carbonate in contact with effluent from the air contactor.

In some cases, the carbon dioxide removal component includes an air contactor configured as a cooling tower, except the volumetric flux of air relative to that of solution is approximately 50 times higher than standard cooling towers (Holmes & Keith, 2012). In some embodiments, the system may be configured to receive a more concentrated carbon dioxide-containing gas stream directly into the metathesis and/or precipitation reactors. In other cases, the system excludes an air contactor but includes point-source capture of carbon dioxide that introduces carbon dioxide containing gas streams directly into the caustic solution and/or the metathesis and/or precipitation reactors. In still other cases, the system excludes carbon dioxide capture and produces a calcium hydroxide alkaline solid product. In other embodiments, the system includes a calcium sulfate leaching reactor in place of the metathesis reactor to supply aqueous calcium sulfate to the precipitation reactor. In some cases, the process is substantially net negative with respect to carbon dioxide emissions.

In some cases, the system may contain one or precipitation reactors configured to receive a portion of (bi)carbonate solution from the air contactor and calcium sulfate saturated solution from the metathesis reactor(s) or from phosphogypsum leaching to precipitate residual solid calcium carbonate minerals and other impurities from the aqueous solution. Systems according to such embodiments may include a component that performs solid-liquid separation. In some cases, the system includes a sulfuric acid recovery module configured to receive sulfuric acid from the electrolyzer. In embodiments, the electrolyzer produces gaseous hydrogen and oxygen. In still other embodiments, the system is configured to perform additional steps for selective recovery of critical elements from the calcium sulfate feedstock. In some cases, the precipitated calcium carbonate may be beneficially used as a component of cement or concrete.

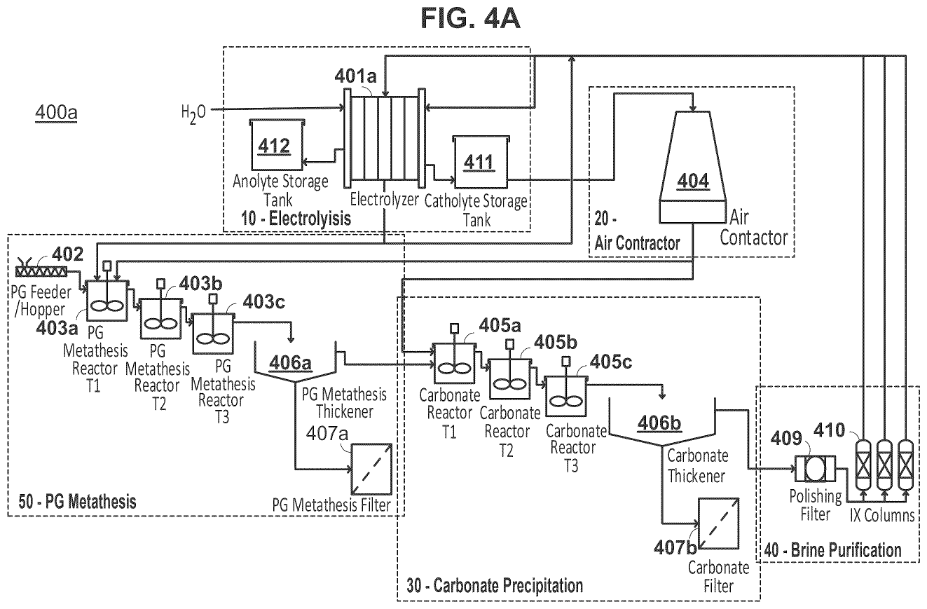

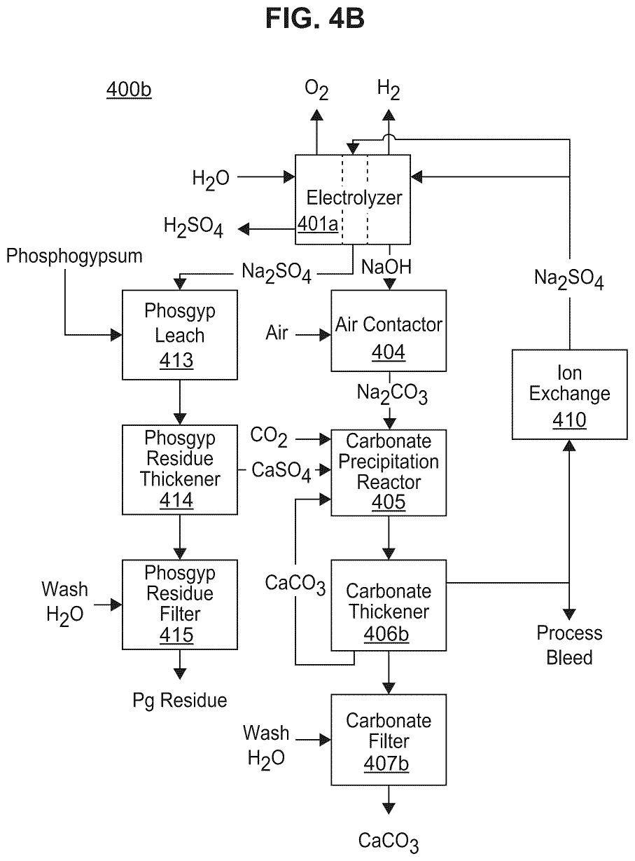

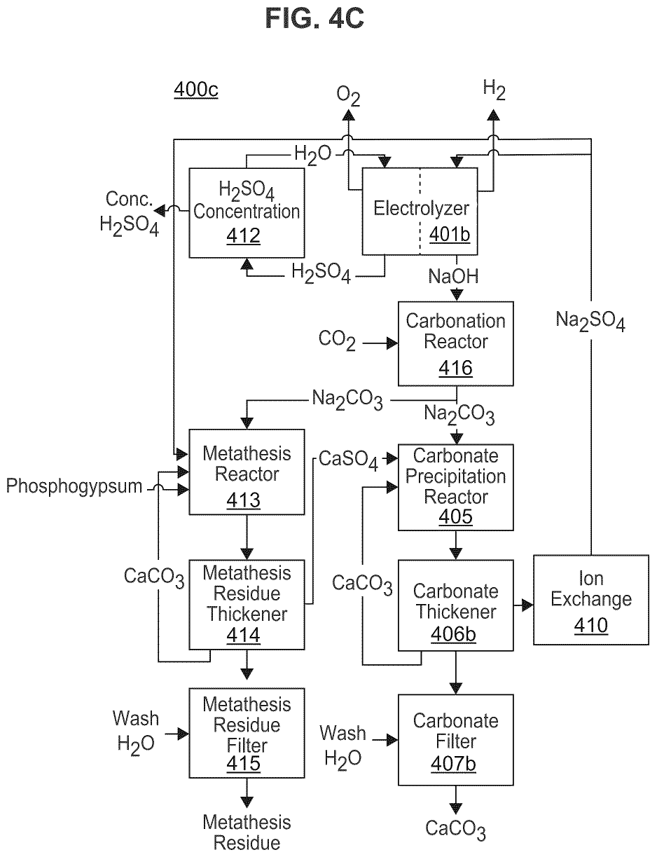

FIG. 4A presents a schematic diagram of a system according to an embodiment of the invention. System 400a for waste gypsum upcycling includes a three-compartment electrolyzer where sodium sulfate is converted to sodium hydroxide (>0.5M), sulfuric acid (>0.5M), hydrogen and oxygen; an air contactor where sodium hydroxide is converted to sodium (bi)carbonate; a series of metathesis reactors where solid calcium sulfate is converted to calcium carbonate; a series of carbonate reactors where residual calcium is precipitated from the sulfate stream; and, a series of water treatment components where the sodium sulfate brine is purified and returned to the electrolyzer. In particular, system 400a includes electrolysis components 10 including electrolyzer 401 fluidically connected to anolyte storage and recirculation tank 412 and catholyte storage and recirculation tank 411. Also included are carbon dioxide removal components 20 comprising air contactor 404. In addition, system 400a includes components 50 for carrying out metathesis comprising feeder/hopper 402, fluidically connected metathesis reactors 403a-403c, thickener 406a and filter 407a. Carbonate precipitation components 30 include carbonate reactors 405a-405c, thickener 406b, and filter 407b. Treatment components 40 include polishing filter 409, and ion exchange columns 410.

Aqueous sulfate is electrolyzed in electrolyzer 401. Anolyte and catholyte in electrolyzer 401a may be stored in anolyte storage tank 412 and catholyte storage tank 411, respectively, and recirculated back to the electrolyzer, if desired. Basic solution from the electrolyzer is provided to air contactor 404, which is configured to generate an aqueous carbonate, which is then subjected to metathesis. Waste gypsum from feeder/hopper 402 and the aqueous carbonate are subjected to metathesis in series of metathesis reactors 403a-403c where solid calcium sulfate is converted to calcium carbonate. The resulting product is provided to thickener 406a and filter 407a. Subsequently, residual calcium is precipitated from the sulfate stream in carbonate reactors 405a-405c, and provided to thickener 406b and filter 407b. Regenerated aqueous sulfate is treated in polishing filter 409 and ion exchange columns 410 before being returned to electrolyzer 401.

FIG. 4B depicts calcium sulfate being introduced to the carbonate precipitation reactor via a gypsum leach rather than via metathesis. System 400b includes three-chamber electrolyzer 401a configured to electrolyze an aqueous sulfate (Na₂SO₄), and produce an acidic solution (H₂SO₄) and a basic solution (NaOH). Aqueous sulfate that passes through the electrolyzer is employed to leach waste gypsum in leaching reactor 413. Resulting gypsum-saturated liquid is provided to a thickener 414, from which calcium sulfate (CaSO₄) is removed and provided to precipitator 405. Remaining gypsum residue is filtered out in filter 415. The basic solution from electrolyzer 404 is provided to air contactor 404 for carbonation, resulting in the production of sodium carbonate (Na₂CO₃). The sodium carbonate is provided to precipitator 405 along with the calcium sulfate to produce precipitated calcium carbonate (CaCO₃), which is then provided to carbonate thickener 406b. The PCC is washed and filtered in filter 407b.

Aqueous sulfate separated from the PCC is treated in ion exchange columns 410, and recirculated to the electrolyzer 401a.

FIG. 4C depicts a system configured to react carbon dioxide with base solution via point source capture rather than direct air capture. System 400c in FIG. 4C includes a similar arrangement to FIG. 4B, with the exceptions that electrolyzer 401b includes two chambers, a storage tank 412 is provided for sulfuric acid concentration, regenerated aqueous sulfate is recirculated directly to the leaching reactor 413, and a point-source carbonation reactor 416 is included rather than air contactor 404.

### Systems for Acid Enhanced Weathering of Silicate Materials and Carbon Mineralization

Embodiments of the invention involve conversion of aqueous magnesium and/or calcium sulfate solutions produced by sulfuric acid leaching of magnesium and/or calcium bearing silicate rocks to recycled sulfuric acid and hydroxide solutions, followed by mineralization of magnesium carbonate, magnesium hydroxycarbonate, magnesium hydroxide, calcium carbonate or a combination of these products. Systems according to embodiments of the invention include an electrolyzer configured to receive soluble sulfate salt solutions, such as sodium sulfate or other soluble sulfate salts, and produce separate sulfuric acid and base solution streams. The electrolyzer can be configured to produce gaseous hydrogen and oxygen in addition to sulfuric acid and base solution. In embodiments where the formation of carbonate solids is desired, the system is configured to include a carbon dioxide removal component. The carbon dioxide removal component is configured to receive a portion of basic solution from the electrolyzer and generate an aqueous (bi)carbonate solution. Sulfuric acid produced in the electrolyzer may have a pH range between −1 to 2, such as pH 0 to pH 0.5 or pH 1 to pH 2. The produced acid is returned for silicate leaching, where the dissolution of silicate minerals neutralizes some or all of the acidity to generate calcium and/or magnesium sulfate-containing solutions that are higher pH than the sulfuric acid feed solution. For example, for a pH 0 feed solution containing ~1 M sulfuric acid, the solution exiting the silicate leaching reactor will have a pH 2 or higher. In some cases, the silicate leach is configured as a heap leach where sulfuric acid is sprinkled over a hydraulically-contained pile of geologic material, such as ultramafic mine tailings. In other cases, the silicate leach is configured as a vat leach or series of vat leaches. In specific versions, the silicate leach is configured as a co-current leach or a countercurrent leach in several steps, such as 2-5 steps. The aqueous solution exiting the silicate leaching system may contain partially neutralized magnesium and/or calcium sulfate along with iron and leached critical elements such as aqueous lithium sulfate. The solid residue exiting the leaching system may contain critical element-enriched residue such as an aluminum, iron, or cobalt oxide-enriched residue, as well as silica residue consisting of amorphous silica with or without secondary silicate minerals. In some cases, a split of the caustic stream may be used for multi-step neutralization to selectively separate metals from the silicate leach solution by hydrolysis, with a component that performs solid-liquid separation in each step. The solid products of multi-step neutralization may include an iron oxyhydroxide solid product, a cobalt hydroxide product, a manganese hydroxide product, or other products. The solution exiting multi-step neutralization may contain a higher purity magnesium and/or calcium sulfate solution. The leached magnesium and/or calcium sulfate solution is returned to a precipitator configured to receive carbonate and bicarbonate solutions from the air contactor to precipitate solid magnesium and/or calcium (bi)carbonate minerals. Also included is a component that performs solid-liquid separation. Purification of the brine exiting the precipitator may be included to prevent scaling and fouling of electrolyzer components. In some cases, aqueous solution from the precipitator is combined with the remainder of base solution produced in the electrochemical system to precipitate residual calcium and magnesium as calcium or magnesium carbonate, hydroxide, hydroxycarbonate, or combination thereof. In some cases, additional components for brine treatment such as filters (e.g., polishing filters) and ion exchange columns may be used to selectively extract valuable elements or to remove other impurities from the aqueous solution, such that a purified sulfate brine such as sodium sulfate is produced.

In embodiments, the system is configured for selective recovery of valuable elements from the silicate feedstock, such as directly from a sulfate leaching reactor or from any other brine purification step. In embodiments, the silicate residue from the silicate leaching step is used as supplementary cementitious material (SCM) or as a substitute for precipitated silica. In other embodiments, the alkaline precipitated material as magnesium carbonate, magnesium hydroxide, and/or magnesium hydroxycarbonate and/or calcium carbonate is beneficially used as a component of cement or concrete. In some cases, the process is substantially net negative with respect to carbon dioxide emissions. In another embodiment, the system excludes an air contactor to produce only hydroxide solid products. In another embodiment, the system includes both an air contactor and a point-source capture system that introduces carbon dioxide containing gas streams directly into the precipitation reactor.

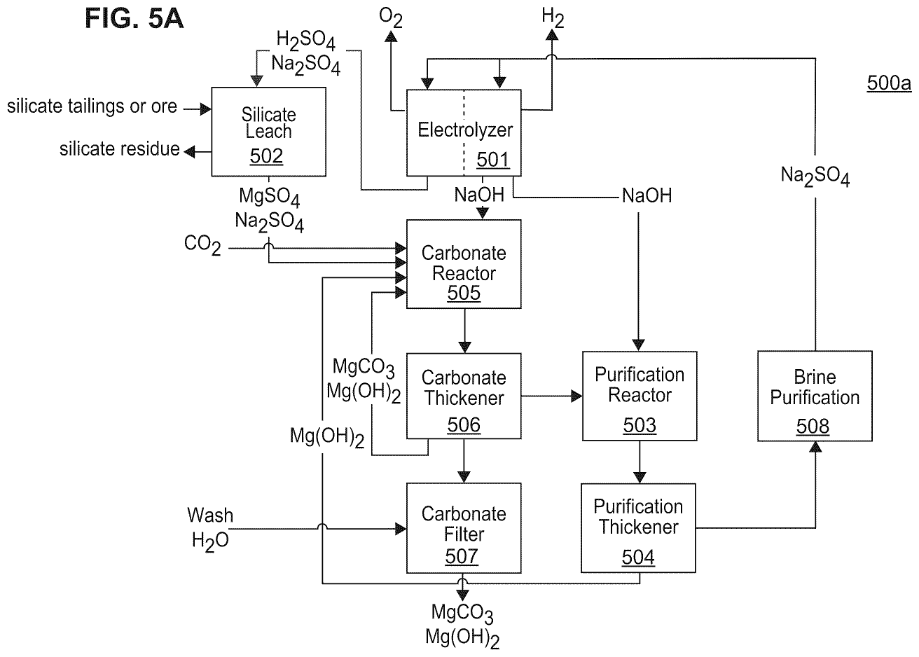

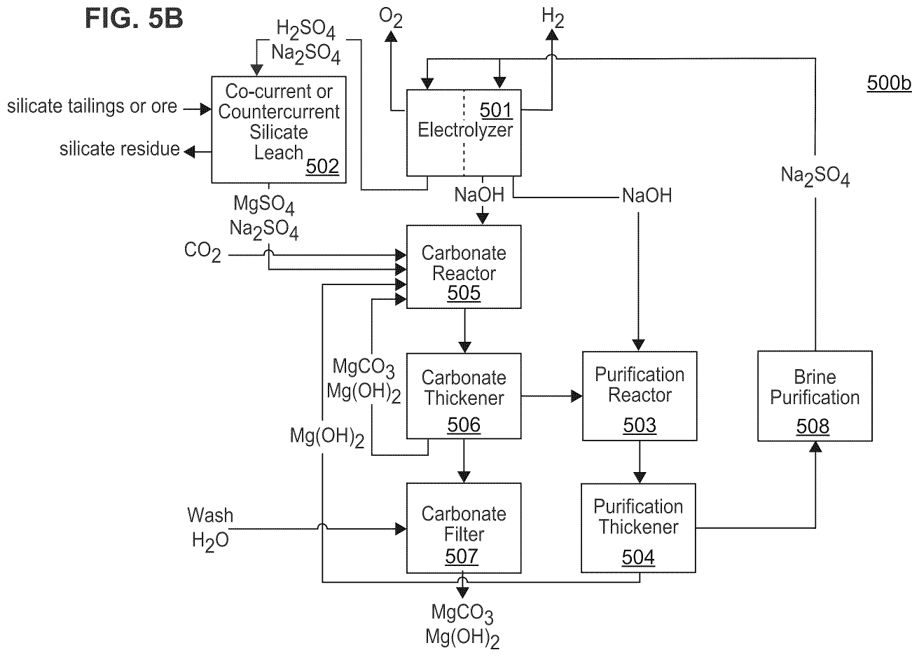

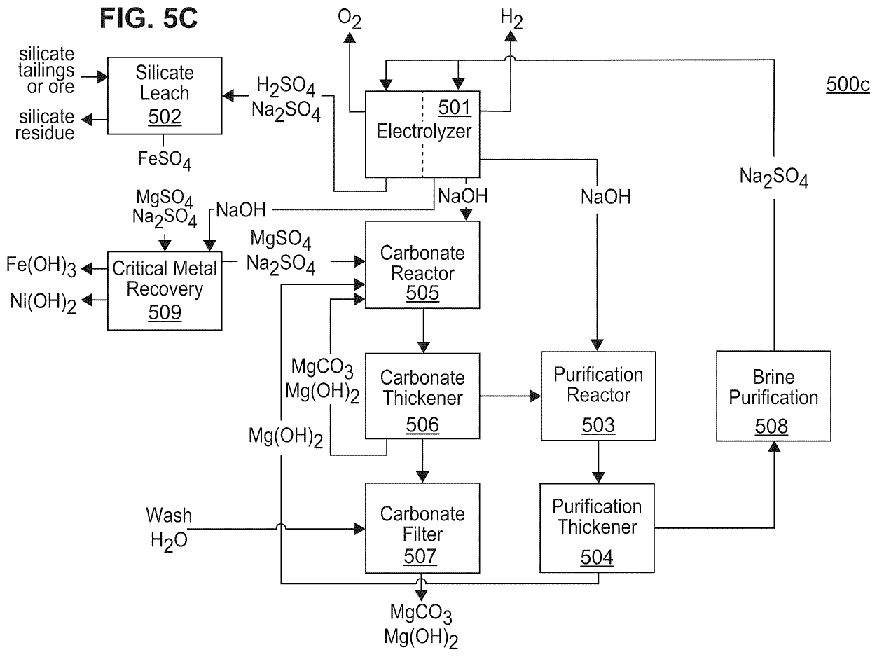

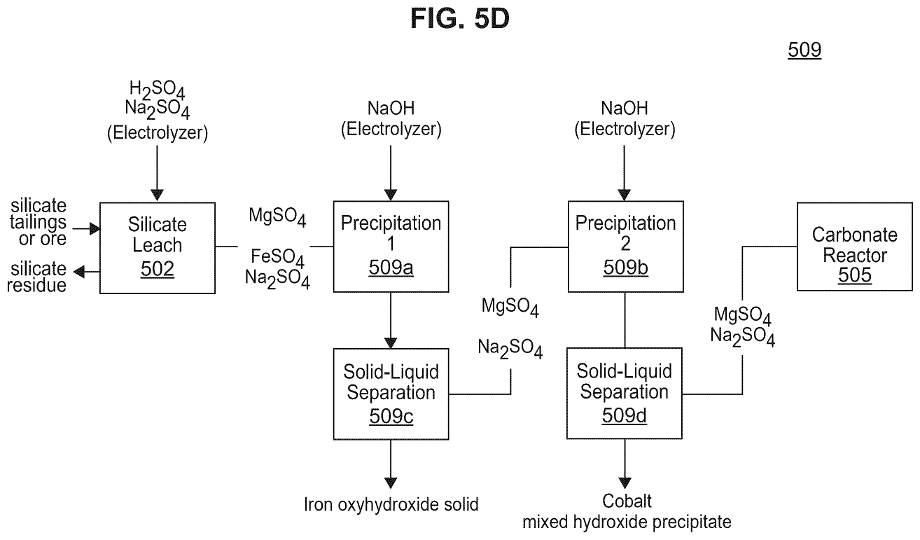

FIG. 5A-5D depict systems for sulfuric acid leaching and accelerated chemical weathering of geological material, such as ultramafic mine tailings, with carbon dioxide removal and permanent sequestration and critical element extraction. System 500a includes electrolyzer 501, which is configured to electrolyze aqueous sulfate (Na₂SO₄) and produce a basic solution (NaOH) and an acidic solution (H₂SO₄). In the example of FIG. 5A, electrolyzer 501 possesses two compartments and is configured to produce gaseous oxygen (O₂) and hydrogen (H₂). The acidic solution along with residual aqueous sulfate is provided to leaching reactor 502, resulting in the generation of magnesium sulfate (MgSO₄). The basic solution from electrolyzer 501, magnesium sulfate and sodium sulfate from leaching reactor 502, and carbon dioxide (CO₂) are provided to precipitator/carbonate reactor 505 configured to precipitate magnesium hydroxide (Mg(OH)₂) and magnesium carbonate (MgCO₃). These products are provided to thickener 506 for further concentration and liquid separation. The magnesium hydroxide and magnesium carbonate may be returned to the precipitator 505. Thickened precipitate is provided to filter 507 where impurities may be removed with water (H₂O). Liquid separated in thickener 506 and basic solution from electrolyzer 501 are provided to purification reactor 503. Residual magnesium compounds are purified from the sulfate stream, thickened in thickener 504, and returned to carbonate reactor 505. Regenerated sulfate is purified in purifier 508—which may include, e.g., a filter and/or ion exchange columns—and recirculated to the electrolyzer 501 for electrolysis. FIG. 5B depicts leaching of geological material by countercurrent vat leaching rather than via a single-step agitated or heap leach. System 500b depicted in FIG. 5B includes the same elements as those described above with respect to FIG. 5A, except that leach reactor 502 is configured to carry out countercurrent vat leaching.

In addition to the elements discussed above with respect to FIG. 5A, system 500c of FIG. 5C includes reactor 509 configured for critical element recovery. Sulfates (e.g., FeSO₄, NiSO₄, MgSO₄, Na₂SO₄) from leaching reactor 502 are provided to reactor 509, and metals (e.g., Fe(OH)s, Ni(OH)₂) may be produced using the basic solution (NaOH). Other sulfates (e.g., MgSO₄, Na₂SO₄) are provided to precipitator/carbonate reactor 505. FIG. 5D depicts a multi-stage neutralization to produce a mixed hydroxide precipitate to selectively separate metals (e.g., iron, and cobalt, manganese, magnesium, and calcium). As shown in FIG. 5D, reactor 509 may be comprised of precipitators 509a and 509b, and filters 509c and 509d. The sulfates (e.g., FeSO₄, NiSO₄, MgSO₄, Na₂SO₄) from leaching reactor 502 are provided to precipitator 509a where they are combined with basic solution (NaOH) from electrolyzer 501. Filter 509c is configured to filter out a resulting metal hydroxide, in this case Fe(OH)s. The remaining aqueous sulfates (e.g., NiSO₄, MgSO₄, Na₂SO₄) are provided for precipitator 509b, where they are combined with basic solution (NaOH) from electrolyzer 501. Filter 509d is configured to filter out a resulting metal hydroxide, in this case Ni(OH)₂. Remaining aqueous sulfates (e.g., MgSO₄, Na₂SO₄) are provided to carbonate reactor 505.

### Systems for Magnesium Sulfate Waste Upcycling to Sulfuric Acid and Carbon Mineralization

In other examples, the invention involves converting solid or aqueous magnesium sulfate waste, such as waste derived from lithium extraction from silicate minerals such as lithium magnesium clay minerals, as a feedstock for electrolytic sulfuric acid, hydrogen, and precipitated magnesium (hydroxy)carbonate production. Systems according to such embodiments comprise an electrolyzer configured to receive soluble sulfate salt solutions and produce separate sulfuric acid and base solution streams. In some cases, the electrolyzer may be configured to produce and recover gaseous hydrogen and oxygen. In embodiments, the system may include a carbon dioxide removal component configured to receive a portion of base solution from the electrolyzer and generate an aqueous carbonate and bicarbonate solution using carbon dioxide derived from a gaseous source such as air or an industrial point source. In some cases, the system performs a series of one or more magnesium (hydroxy)carbonate precipitation steps and is configured to receive solid or aqueous magnesium sulfate and the majority of (bi)carbonate solution from the carbonation system and precipitate solid magnesium (hydroxy)carbonate minerals. Embodiments of the systems also include a component that performs solid-liquid separation. In other cases, the system is configured to produce solid magnesium hydroxide from the solid or aqueous magnesium sulfate source. In some cases the system may include one or more precipitation reactors configured to receive a portion of (bi)carbonate solution from the air contactor and magnesium sulfate solution to precipitate residual solid magnesium hydroxide minerals and other impurities from the aqueous solution, including a component that performs solid-liquid separation. In some instances, additional treatment components such as ion exchange columns may be employed to remove other impurities from the sulfate brine prior to recirculating the sulfate brine to the electrolyzer. In some cases, the system includes a sulfuric acid recovery module configured to receive sulfuric acid from the electrochemical system to be used for a suitable purpose, such as acid leaching of lithium from lithium magnesium claystone. In still other embodiments, the system integrates additional steps for selective recovery of critical elements from the solid or aqueous magnesium sulfate feedstock. In some cases, the precipitated magnesium (hydroxy)carbonate and/or magnesium hydroxide may be beneficially used as a component of cement or concrete.

In some cases, the carbon dioxide removal component includes an air contactor configured as a cooling tower, except the volumetric flux of air relative to that of solution is approximately 50 times higher than standard cooling towers. In some embodiments, the system may be configured to receive a more concentrated carbon dioxide-containing gas stream directly into the precipitation reactors. In other cases, the system excludes an air contactor but includes point-source capture of carbon dioxide that introduces carbon dioxide containing gas streams directly into the precipitation reactors. In still other cases, the system excludes carbon dioxide capture and produces a magnesium hydroxide solid product. In some cases, the process is substantially net negative with respect to carbon dioxide emissions.

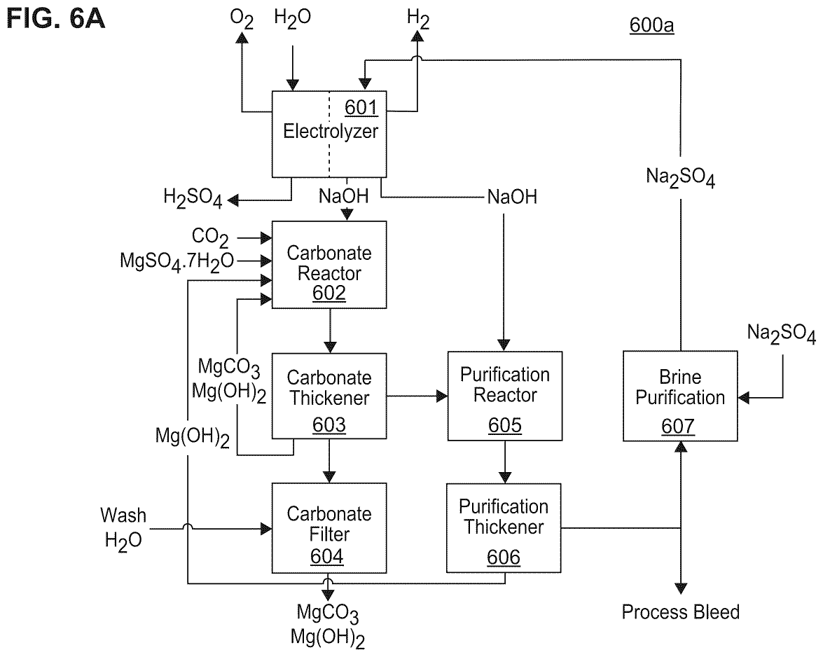

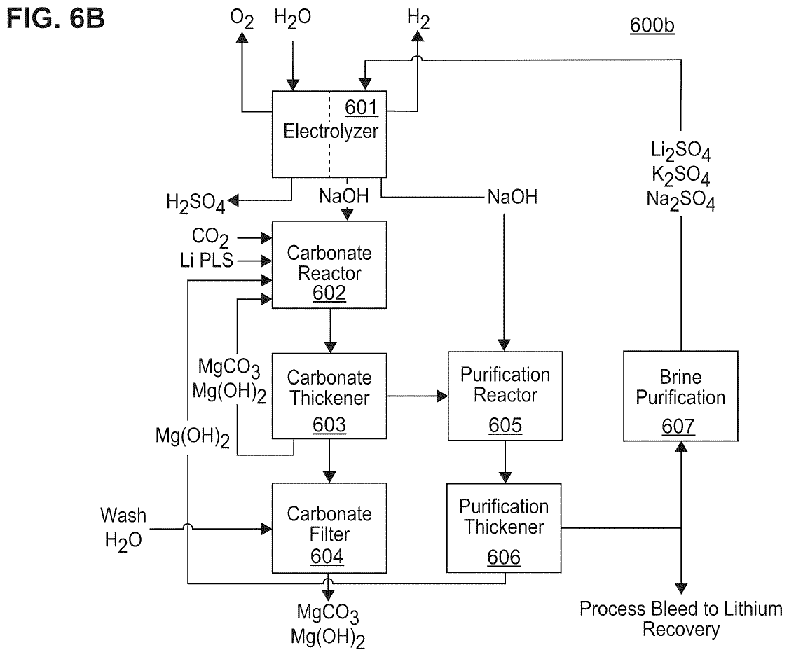

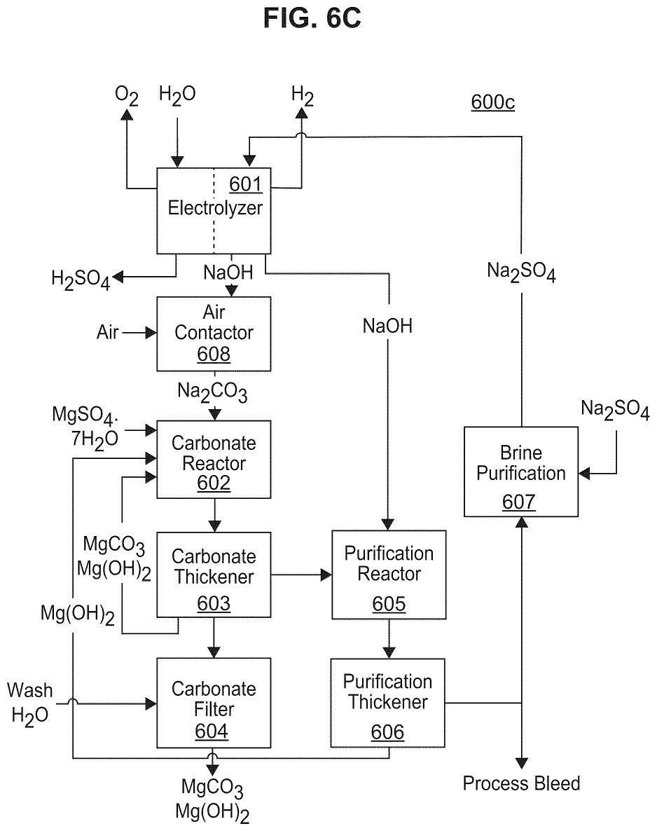

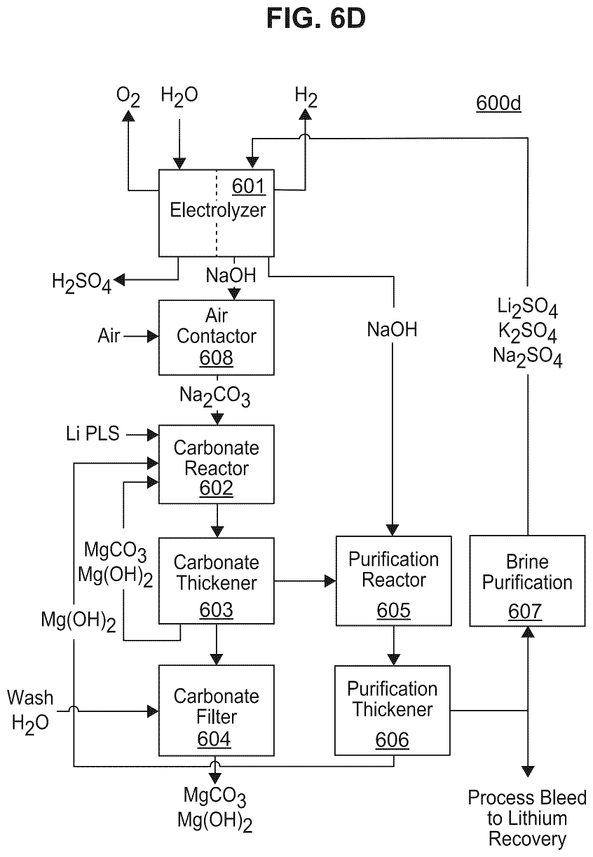

FIG. 6A-6D present flow diagrams for sulfate waste upcycling. FIG. 6A depicts magnesium sulfate (MgSO₄·7H₂O, s) waste upcycling to sulfuric acid, magnesium carbonate and magnesium hydroxide, hydrogen and oxygen, with point source capture of carbon dioxide. System 600a includes electrolyzer 601, which is configured to electrolyze aqueous sulfate (Na₂SO₄) and produce a basic solution (NaOH) and an acidic solution (H₂SO₄). In the example of FIG. 6A, electrolyzer 601 possesses two compartments and is configured to produce gaseous oxygen (O₂) and hydrogen (H₂). The basic solution, carbon dioxide (CO₂), and magnesium sulfate are provided to precipitator/carbonate reactor 602 configured to precipitate magnesium hydroxide (Mg(OH)₂) and magnesium carbonate (MgCO₃). These products are provided to thickener 603 for further concentration and liquid separation. The magnesium hydroxide and magnesium carbonate may be returned to the precipitator 602. Thickened precipitate is provided to filter 604 where impurities may be removed with water (H₂O). Liquid separated in thickener 603 and basic solution from electrolyzer 601 are provided to purification reactor 605. Residual magnesium compounds such as magnesium carbonate are purified from the sulfate stream, thickened in thickener 606, and returned to carbonate reactor 602. Regenerated sulfate is purified in purifier 607—which may include, e.g., a filter and/or ion exchange columns—and recirculated to the electrolyzer for electrolysis.

FIG. 6B depicts a system that receives neutralized leachate (Li PLS) from sulfuric acid extraction of lithium ore, such as lithium claystone, and conversion of the aqueous magnesium sulfate to solid magnesium carbonate and magnesium hydroxide, sulfuric acid, hydrogen and oxygen, with point source capture of carbon dioxide. System 600b in FIG. 6B includes the same components as FIG. 6A, with the exception that lithium is extracted.

FIG. 6C depicts a system configured for magnesium sulfate (MgSO₄·7H₂O, s) waste upcycling to sulfuric acid, magnesium carbonate and magnesium hydroxide, hydrogen and oxygen, with direct air capture of carbon dioxide. System 600c in FIG. 6C includes the same components as FIG. 6A, with the addition of air contactor 608 configured to produce an aqueous carbonate (Na₂CO₃) by reacting the basic solution (NaOH) with carbon dioxide in the air.

FIG. 6D depicts a system that receives neutralized leachate (Li PLS) from sulfuric acid extraction of lithium ore, such as lithium claystone, and is configured to convert aqueous magnesium sulfate to solid magnesium carbonate and magnesium hydroxide, sulfuric acid, hydrogen and oxygen, with direct air capture of carbon dioxide. System 600d in FIG. 6D includes the same components as FIG. 6B, with the addition of air contactor 608 configured to produce an aqueous carbonate (Na₂CO₃) by reacting the basic solution (NaOH) with carbon dioxide in the air.

The following are offered by way of example and not by way of limitation.

### EXPERIMENTAL

### Example 1

Batch experiments were conducted to determine the rate of gypsum and phosphogypsum conversion to calcium carbonate solids in a metathesis reactor, which has an overall reaction:

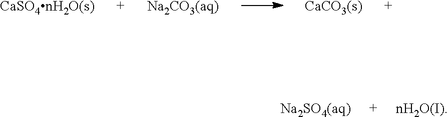

To start the experiments, solid gypsum (CaSO₄·2H₂O) or synthetic phosphogypsum (PG) was slurried in 0-1 M Na₂SO₄ at ambient pressure and temperature along with 5 wt. % calcium carbonate (CaCO₃) seed material. A solution was prepared to mimic reaction with air contactor solution effluent containing 0.1 M NaOH and 0.45 M Na₂CO₃. The slurry was combined with the carbonate solution in a volumetric ratio that varied to adjust the ratio of carbonate (CO₃²⁻) to calcium sulfate (approximately 1:1 volumetric ratio in all cases) in 0.55 M Na₂SO₄ initial process solution. Experimental conditions are outlined in Table 1.

TABLE 1
Gypsum carbonation batch experimental conditions.

| | | CaCO₃ | Initial | |
|---|---|---|---|---|
| Experiment | | Seed, | Gypsum, | Na₂CO₃:CaSO₄ |
| Number | Gypsum Source | wt. % | wt. % | Stoichiometry |
| CP01-152 | FCC Grade Gypsum | 5.0 | 7.5 | 0.5 |
| CP01-153 | FCC Grade Gypsum | 5.0 | 7.5 | 0.7 |
| CP01-154 | FCC Grade Gypsum | 5.0 | 7.5 | 1.0 |
| CP01-156 | Phosphogypsum | 5.0 | 7.2 | 1.0 |
| | (Synthetic) | | | |
| CP02-34 | Phosphogypsum | 5.0 | 7.2 | 0.9 |
| | (Synthetic) | | | |
| CP02-36 | Phosphogypsum | 5.0 | 7.2 | 0.7 |
| | (Synthetic) | | | |
| CP02-47 | Phosphogypsum | 5.0 | 6.4 | 0.6 |
| | (Real) | | | |
| CP02-48 | Phosphogypsum | 5.0 | 6.4 | 0.4 |
| | (Real) | | | |

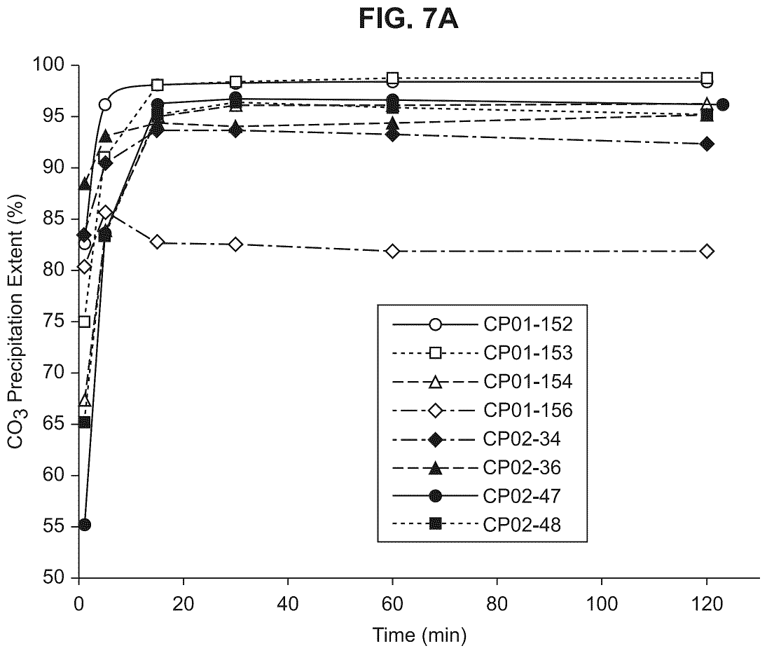

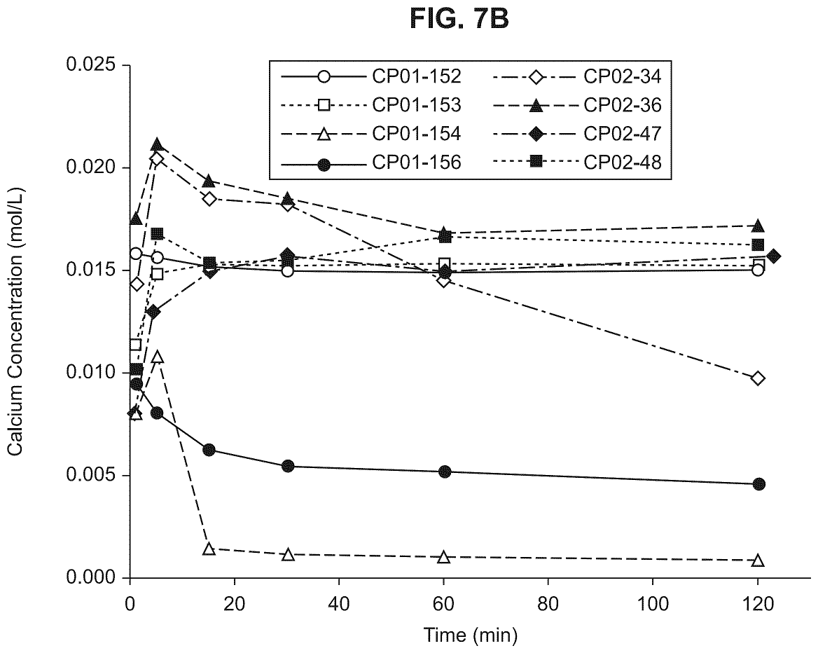

The time evolution of the calcium concentration and extent of carbonate precipitation was recorded (FIG. 7A-7B). The reaction was observed to be rapid over a range of conditions.

### Example 2

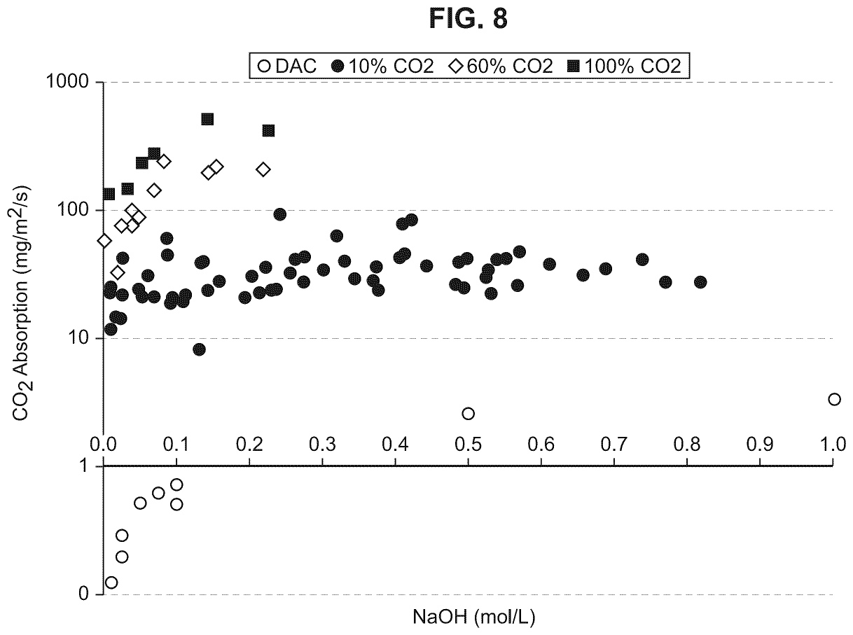

A series of experiments were carried out investigating the kinetics of carbon dioxide uptake using CO₂ concentrations ranging from 400 ppm (air) to 100%. The results are given in FIG. 8. The kinetics of CO₂ absorption from air by NaOH decreased significantly at NaOH concentrations s 0.1 M NaOH. Below 0.1 M NaOH the equipment required to capture CO₂ from air became impractically large. At higher concentrations of CO₂, relatively high flux rates could be achieved at NaOH concentrations s 0.1 M.

In practice, carbon dioxide removal from air using base (e.g. NaOH) solution is feasible when the solution is sufficiently concentrated (Holmes & Keith, 2012; Keith et al., 2018). Carbon dioxide capture by base solutions can be accomplished using air contactors designed similar to cooling towers, except the volumetric flux of air relative to that of solution is approximately 50 times higher than standard cooling towers (Holmes & Keith, 2012). In carbon dioxide removal air contactors, fans blow air across a packing material that is covered in a liquid film consisting of the base-containing solution (Keith et al., 2018). The packing material maximizes the air-solution interfacial area to speed up carbon dioxide capture rates. As the concentration of base solution decreases, the rate of carbon dioxide uptake and subsequent conversion to aqueous carbonate decreases, making required size of the air contactor exponentially increase.

### Example 3

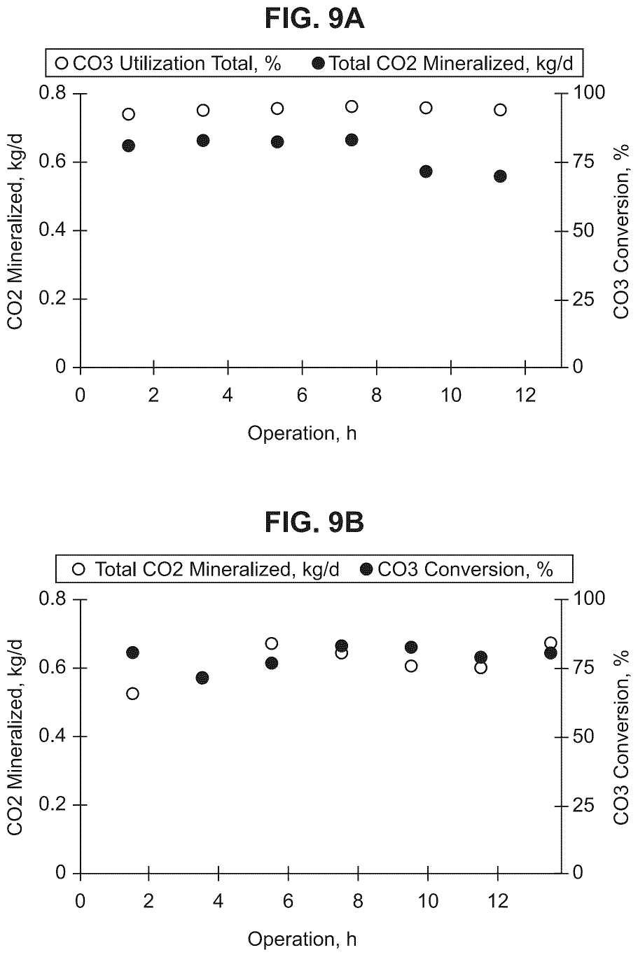

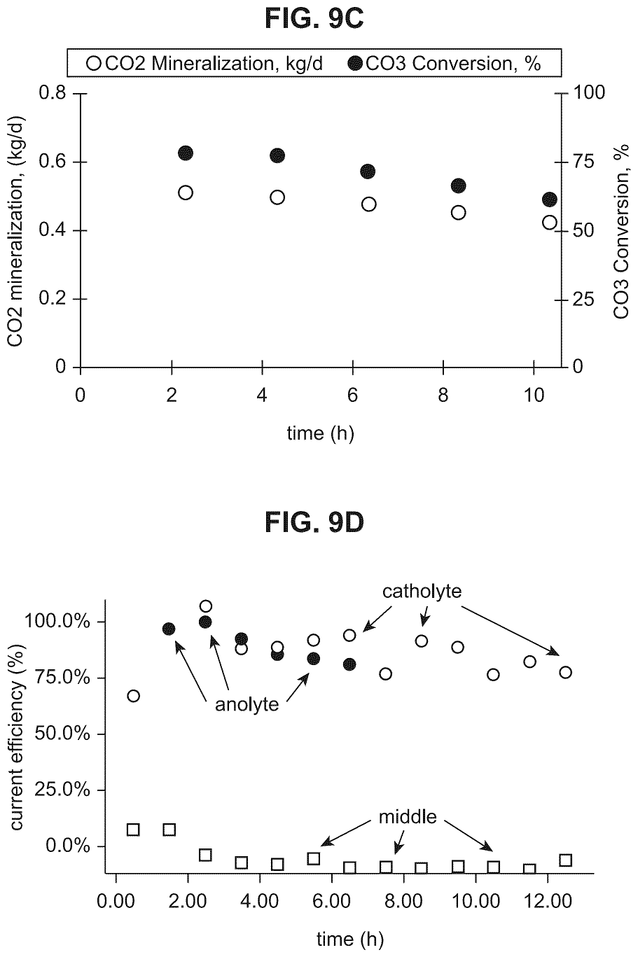

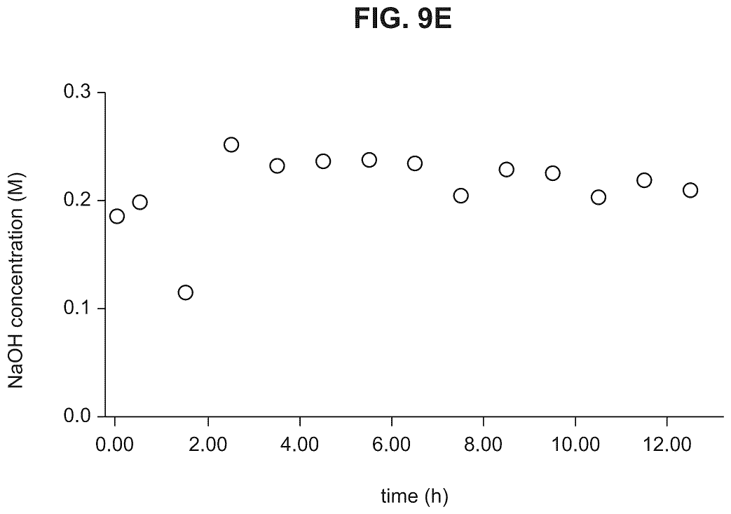

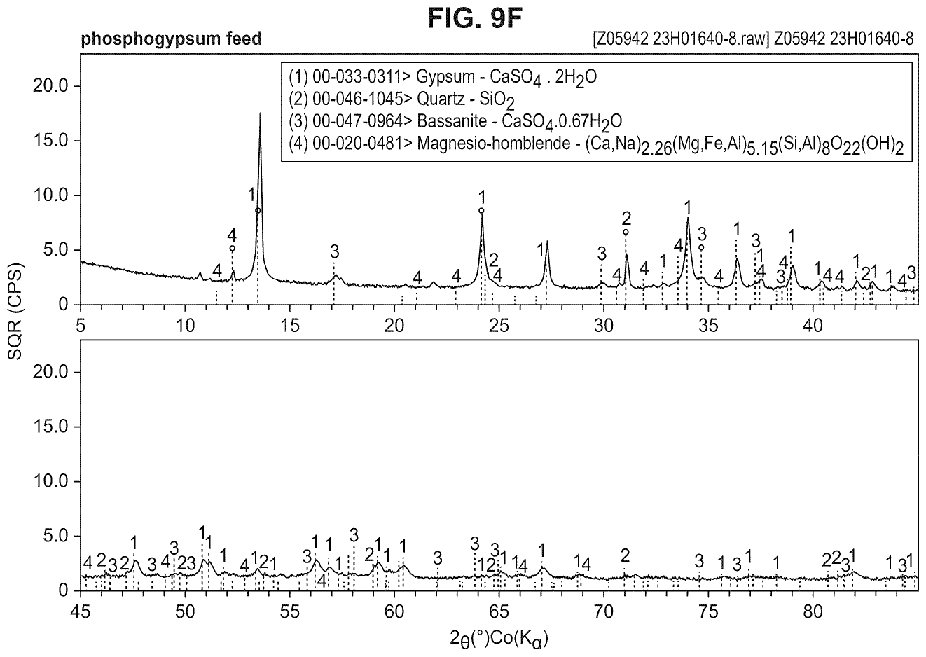

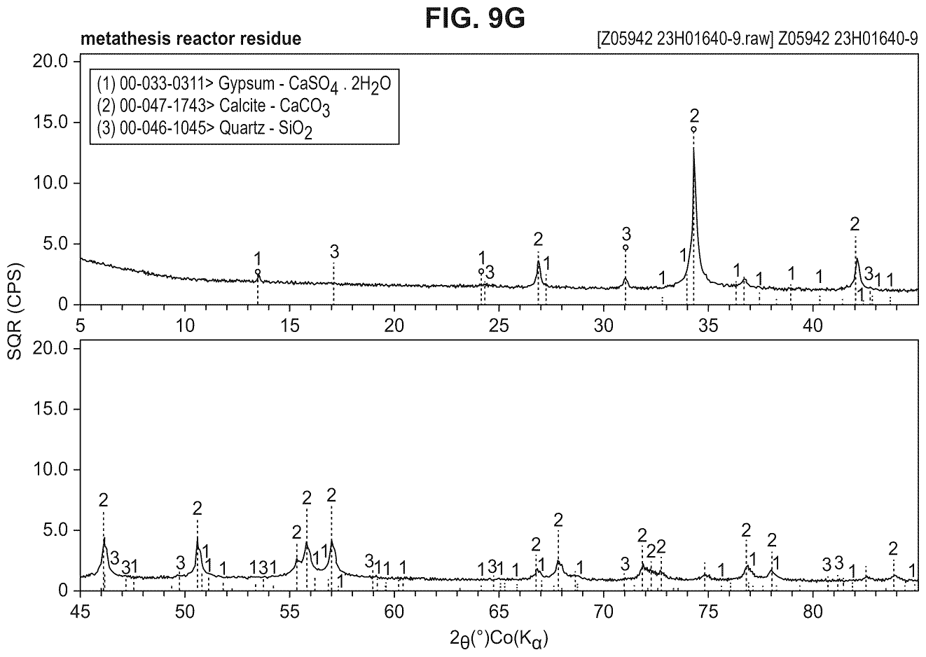

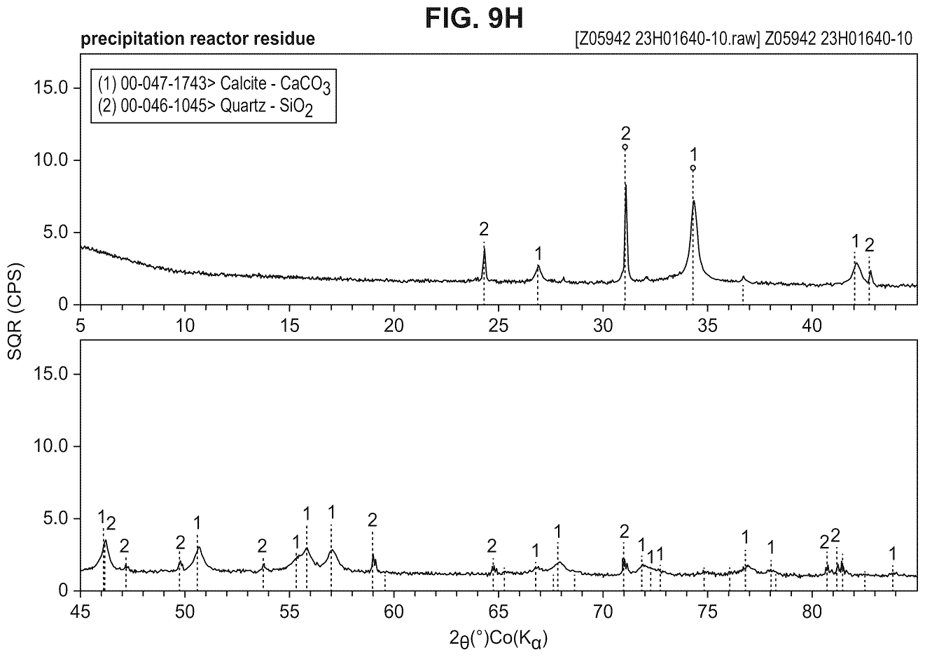

An integrated pilot system was constructed according to the process flow diagram depicted in FIG. 4A. The system was sized to continuously mineralize 5 kg/day CO₂ at nameplate capacity. Three experiments were conducted for >12 hour duration using waste gypsum from phosphoric acid production (e.g., phosphogypsum; FIG. 9A-9B) and waste gypsum residue from mining (FIG. 9C) as the feed materials to the metathesis reactors (flow 402 in FIG. 4A). Steady-state operating conditions were achieved after approximately 8 hours of reaction time, and the flow rates were configured to produce sulfuric acid at a steady-state concentration of ~0.5M by continuously feeding the anolyte solution with water and removing produced sulfuric acid solution. The three-chamber electrolyzer produced acid and base with stable current efficiencies in each chamber and stable catholyte concentration (example data from one experiment given in FIG. 9D-9E). The extent of carbonate mineralization was controlled by adjusting the gypsum feed flow rate to the metathesis reactors relative to the rate of carbonate solution feed, which is limited by base production in the electrolyzer. The carbonate reaction extent was measured by carbonate titration approximately every two hours, and the extent of carbonate reaction in the metathesis reactor was maintained from 75-95% (FIG. 9A-9C). The mineralogical composition of the solid carbonate products from the metathesis residue and precipitation reactor residue were characterized by X-ray diffraction and contain a mixture of residual gypsum and the calcium carbonate polymorph calcite (example from phosphogypsum feed given in FIG. 9F-9H). The reactor flows can be adjusted to control the extent of gypsum conversion to calcium carbonate in the metathesis residue solids. Solids produced in these experiments ranged in composition from 45-70% CaCO₃, 7-45% CaSO₄·2H₂O (residual gypsum), with the balance containing inert silicate minerals such as quartz (SiO₂). The precipitation reactor solids contain 98-99% CaCO₃ and comprise 4-20% of the total mineralization.

### Example 4

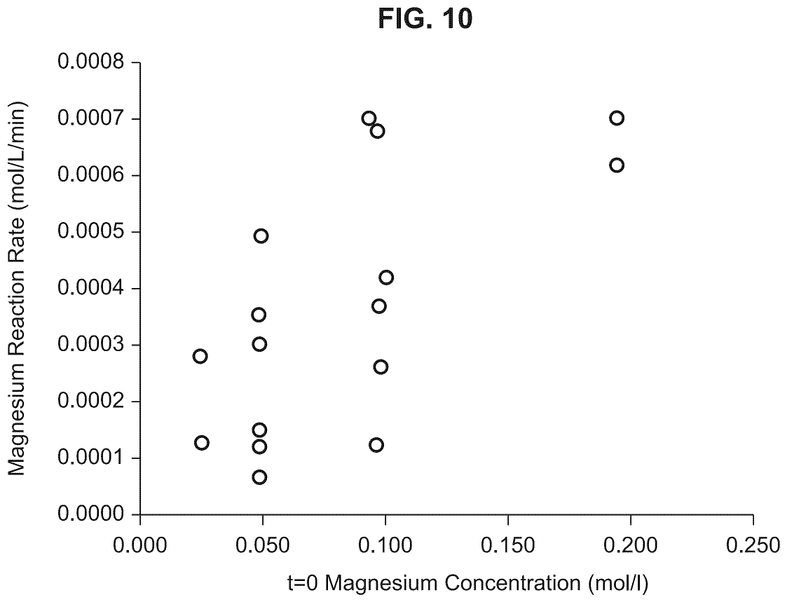

Batch experiments were conducted to determine the rate of magnesium carbonate precipitation from a mixture of magnesium sulfate and sodium carbonate. To start the experiments the pH of a solution of sodium carbonate (0.01-0.08 M) and sodium sulfate (1 M) was adjusted to 8.8-11.0 with sulfuric acid. This solution was mixed with magnesium carbonate seed (10 wt %). A magnesium sulfate solution was then added and the time evolution of magnesium precipitation was measured. Magnesium precipitation rates (FIG. 10) in these experiments of 6×10⁻⁵-7×10⁻⁴ mol/L/min were observed, and the product was determined to be hydromagnesite by X-ray diffraction.

### REFERENCES CITED

Azdarpour A., Asadullah M., Junin R., Manan M., Hamidi H. and Mohammadian E. (2014) Direct carbonation of red gypsum to produce solid carbonates. Fuel Processing Technology 126, 429-434.
Bea S. A., Wilson S., Mayer K. U., Dipple G., Power I. and Gamazo P. (2012) Reactive transport modeling of natural carbon sequestration in ultramafic mine tailings. Vadose Zone Journal 11.
Beltrami D., Cote G., Mokhtari H., Courtaud B., Moyer B. A. and Chagnes A. (2014) Recovery of Uranium from Wet Phosphoric Acid by Solvent Extraction Processes. Chemical Reviews 114, 12002-12023.
Blattler C. L. and Higgins J. A. (2017) Testing Urey's carbonate-silicate cycle using the calcium isotopic composition of sedimentary carbonates. Earth and Planetary Science Letters 479, 241-251.
Davenport J., Getsinger J. and Carroll F. (1965) Wet-Process Phosphoric Acid. Foam Distribution of Sulfuric Acid. Industrial & Engineering Chemistry Process Design and Development 4, 84-88.
Fernández-Díaz, L., Pina, C. M., Astilleros, J. M. & Sánchez-Pastor, N. The carbonatation of gypsum: Pathways and pseudomorph formation. American Mineralogist 94, 1223-1234 (2009).
Ghavam S., Vahdati M., Wilson I. and Styring P. (2021) Sustainable ammonia production processes. Frontiers in Energy Research, 34.
Grguric B., Rosengren N., Fletcher C. and Hronsky J. (2006) Type 2 deposits: Geology, mineralogy, and processing of the Mount Keith and Yakabindie orebodies, Western Australia.
Hamilton J., Wilson S., Turvey C., Morgan B., Tait A., McCutcheon J., Fallon S. and Southam G. (2021) Carbon accounting of mined landscapes, and deployment of a geochemical treatment system for enhanced weathering at Woodsreef Chrysotile Mine, NSW, Australia. Journal of Geochemical Exploration 220, 106655.
Hamilton J. L., Wilson S. A., Morgan B., Harrison A. L., Turvey C. C., Paterson D. J., Dipple G. M. and Southam G. (2020) Accelerating mineral carbonation in ultramafic mine tailings via direct CO₂ reaction and heap leaching with potential for base metal enrichment and recovery. Economic Geology 115, 303-323.
Hicks G. C. (2018) Review of the production of monoammonium phosphate. In Manual of Fertilizer Processing. Routledge. pp. 289-305.
Holmes G. and Keith D. W. (2012) An air-liquid contactor for large-scale capture of CO2 from air. Philosophical Transactions of the Royal Society A: Mathematical, Physical and Engineering Sciences 370, 4380-4403.
IEA (2021) The Role of Critical Minerals in Clean Energy Transitions, Paris, France.
Keith D. W., Holmes G., Angelo D. S. and Heidel K. (2018) A process for capturing CO2 from the atmosphere. Joule 2, 1573-1594.
King M., Moats M. and Davenport W. G. (2013) Sulfuric acid manufacture: analysis, control and optimization. Newnes.
Kyriakou V., Garagounis I., Vourros A., Vasileiou E. and Stoukides M. (2020) An electrochemical haber-bosch process. Joule 4, 142-158.
La Plante, E. C. et al. Saline Water-Based Mineralization Pathway for Gigatonne-Scale CO2 Management. ACS Sustainable Chemistry & Engineering 9, 1073-1089 (2021).
Lackner K. S. (2002) Carbonate chemistry for sequestering fossil carbon. Annual review of energy and the environment 27, 193-232.
Lal, R. Carbon sequestration. Philosophical Transactions of the Royal Society B: Biological Sciences 363, 815-830 (2008).
Liu H. (2014) Ammonia synthesis catalyst 100 years: Practice, enlightenment and challenge. Chinese Journal of Catalysis 35, 1619-1640.
Lu, X., Carroll, K. J., Turvey, C. C. & Dipple, G. M. Rate and capacity of cation release from ultramafic mine tailings for carbon capture and storage. Applied Geochemistry 140, 105285 (2022).
Mac Dowell N., Fennell P. S., Shah N. and Maitland G. C. (2017) The role of CO 2 capture and utilization in mitigating climate change. Nature Climate Change 7, 243-249.
Mac Dowell, N., Reiner, D. M. & Haszeldine, R. S. Comparing approaches for carbon dioxide removal. Joule 6, 2233-2239 (2022).
Mattila, H.-P. & Zevenhoven, R. Mineral carbonation of phosphogypsum waste for production of useful carbonate and sulfate salts. Frontiers in Energy Research 3, 48 (2015).
McCutcheon J., Dipple G. M., Wilson S. A. and Southam G. (2015) Production of magnesium-rich solutions by acid leaching of chrysotile: A precursor to field-scale deployment of microbially enabled carbonate mineral precipitation. Chemical Geology 413, 119-131.
Mendes G. d. O., Murta H. M., Valadares R. V., Silveira W. B. d., Silva I. R. d. and Costa M. D. (2020) Oxalic acid is more efficient than sulfuric acid for rock phosphate solubilization. Minerals Engineering 155, 106458.
Meyer N., Vögeli J., Becker M., Broadhurst J., Reid D. and Franzidis J.-P. (2014) Mineral carbonation of PGM mine tailings for CO2 storage in South Africa: A case study. Minerals Engineering 59, 45-51.
Ncongwane M. S., Broadhurst J. and Petersen J. (2018) Assessment of the potential carbon footprint of engineered processes for the mineral carbonation of PGM tailings. International Journal of Greenhouse Gas Control 77, 70-81.
Osman, A. I., Hefny, M., Abdel Maksoud, M., Elgarahy, A. M. & Rooney, D. W. Recent advances in carbon capture storage and utilisation technologies: a review. Environmental Chemistry Letters 19, 797-849 (2021).
Pokrovsky O. S. and Schott J. (2000) Kinetics and mechanism of forsterite dissolution at 25 C and pH from 1 to 12. Geochimica et Cosmochimica Acta 64, 3313-3325.
Power I. M., Harrison A. L., Dipple G. M., Wilson S. A., Kelemen P. B., Hitch M. and Southam G. (2013) Carbon mineralization: from natural analogues to engineered systems. Reviews in Mineralogy and Geochemistry 77, 305-360.
Power I. M., Wilson S. A. and Dipple G. M. (2013) Serpentinite carbonation for CO2 sequestration. Elements 9, 115-121.
Rahmani 0. (2018) CO2 sequestration by indirect mineral carbonation of industrial waste red gypsum. Journal of CO2 Utilization 27, 374-380.
Rahmani O., Junin R., Tyrer M. and Mohsin R. (2014) Mineral carbonation of red gypsum for CO2 sequestration. Energy & fuels 28, 5953-5958.
Rau, G. H. et al. Direct electrolytic dissolution of silicate minerals for air CO2 mitigation and carbon-negative H2 production. Proceedings of the National Academy of Sciences 110, 10095-10100 (2013).
Rau, G. H., Willauer, H. D. & Ren, Z. J. The global potential for converting renewable electricity to negative-CO2-emissions hydrogen. Nature Climate Change 8, 621-625 (2018).
Riahi, K., R. Schaeffer, J. Arango, K. Calvin, C. Guivarch, T. Hasegawa, K. Jiang, E. Kriegler, R. Matthews, G. P. Peters, A. Rao, S. Robertson, A. M. Sebbit, J. Steinberger, M. Tavoni, D. P. van Vuuren. in IPCC, 2022: Climate Change 2022: Mitigation of Climate Change. Contribution of Working Group III to the Sixth Assessment Report of the Intergovernmental Panel on Climate Change (ed J. Skea P. R. Shukla, R. Slade, A. Al Khourdajie, R. van Diemen, D. McCollum, M. Pathak, S. Some, P. Vyas, R. Fradera, M. Belkacemi, A. Hasija, G. Lisboa, S. Luz, J. Malley,) (Cambridge University Press, 2022).
Ruiz-Agudo, E. et al. Experimental study of the replacement of calcite by calcium sulphates. Geochimica et Cosmochimica Acta 156, 75-93 (2015).
Sleep N. H. and Zahnle K. (2001) Carbon dioxide cycling and implications for climate on ancient Earth. Journal of Geophysical Research: Planets 106, 1373-1399.
Sullivan, I. et al. Coupling electrochemical CO2 conversion with CO2 capture. Nature Catalysis 4, 952-958 (2021).
Vogeli J., Reid D., Becker M., Broadhurst J. and Franzidis J.-P. (2011) Investigation of the potential for mineral carbonation of PGM tailings in South Africa. Minerals Engineering 24, 1348-1356.
Wilson S. A., Raudsepp M. and Dipple G. M. (2006) Verifying and quantifying carbon fixation in minerals from serpentine-rich mine tailings using the Rietveld method with X-ray powder diffraction data. American Mineralogist 91, 1331-1341.
Wilson S. A., Dipple G. M., Power I. M., Thom J. M., Anderson R. G., Raudsepp M., Gabites J. E. and Southam G. (2009) Carbon dioxide fixation within mine wastes of ultramafic-hosted ore deposits: Examples from the Clinton Creek and Cassiar chrysotile deposits, Canada. Economic geology 104, 95-112.
Woodall C. M., Lu X., Dipple G. and Wilcox J. (2021) Carbon Mineralization with North American PGM Mine Tailings—Characterization and Reactivity Analysis. Minerals 11, 844. Yu L., Daniels L. M., Mulders J. J., Saldi G. D., Harrison A. L., Liu L. and Oelkers E. H. (2019) An experimental study of gypsum dissolution coupled to CaCO3 precipitation and its application to carbon storage. Chemical Geology 525, 447-461.
Wigley T. (1973) Chemical evolution of the system calcite-gypsum-water. Canadian Journal of Earth Sciences 10, 306-315.
Zeman, F. Energy and material balance of CO2 capture from ambient air. Environmental science & technology 41, 7558-7563 (2007).

Notwithstanding the appended claims, the disclosure is also defined by the following clauses:
1. A method comprising:
   electrolyzing an aqueous sulfate to produce an acidic solution and a basic solution, wherein the electrolyzing comprises the use of an electrolyzer stack of one or more electrochemical cells comprising:
      an anode within an anode chamber containing an anolyte;
      a cathode within a cathode chamber containing a catholyte; and
      a cation exchange membrane separating the anode and cathode chambers;
   extracting a mineral from a mineral source using the acidic solution, thereby producing a sulfate waste product;
   precipitating an inorganic alkaline solid formed from the sulfate waste product, thereby regenerating the aqueous sulfate; and
   recirculating the regenerated aqueous sulfate to the electrolyzer stack for electrolysis.
2. The method according to Clause 1, wherein the cation exchange membrane is configured so that sodium cation (Na⁺) crosses the cation exchange membrane to the cathode chamber.
3. The method according to Clause 1 or 2, wherein the one or more electrolysis cells further comprise an anion exchange membrane.
4. The method according to Clause 3, wherein the anion exchange membrane is configured so that sulfate anion (SO₄²⁻) crosses the anion exchange membrane to the anode chamber.
5. The method according to any one of the preceding clauses, wherein the one or more electrolysis cells further comprise a bipolar membrane.
6. The method according to Clause 5, wherein the method comprises bipolar membrane electrodialysis (BMED).
7. The method according to any one of the preceding clauses, wherein the method comprises a CO₂ sequestering protocol.
8. The method according to Clause 7, wherein the CO₂ sequestering protocol comprises sequestering gaseous CO₂ via direct air capture (DAC).
9. The method according to Clause 7, wherein the CO₂ sequestering protocol comprises sequestering gaseous CO₂ from a point source.
10. The method according to Clause 9, wherein the point source comprises a flue gas.
11. The method according to any one of Clauses 7 to 10, wherein the CO₂ sequestering protocol comprises reacting gaseous CO₂ with the basic solution to produce an aqueous carbonate solution.
12. The method according to Clause 11, wherein the aqueous carbonate solution comprises aqueous bicarbonate.
13. The method according to Clause 11, further comprising concentrating the basic solution.
14. The method according to Clause 13, wherein the concentration of the basic solution ranges from 0.5 M to 2 M.
15. The method according to Clause 13, wherein the pH of the basic solution ranges from 13.7 to 14.3.
16. The method according to any one of Clauses 11 to 15, wherein the basic solution is an alkaline solution.
17. The method according to Clause 16, wherein the alkaline solution comprises ammonia (NH₃).
18. The method according to any one of the preceding clauses, wherein the inorganic alkaline solid is precipitated calcium carbonate (PCC).
19. The method according to any one of the preceding clauses, wherein the inorganic alkaline solid is magnesium carbonate (MgCO₃).
20. The method according to any one of the preceding clauses, wherein the inorganic alkaline solid is magnesium hydroxy carbonate (Mg₅(CO₃)₄(OH)₂·nH₂O).
21. The method according to any one of Clauses 1 to 6, wherein the inorganic alkaline solid is a calcium hydroxide alkaline solid product.
22. The method according to any one of Clauses 1 to 6, wherein the inorganic alkaline solid is a magnesium hydroxide alkaline solid product.
23. The method according to any one of the preceding clauses, wherein the method comprises concentrating the acidic solution.
24. The method according to Clause 23, wherein the concentration of the acidic solution is 0.1 M or greater.
25. The method according to Clause 23, wherein the pH of the acidic solution ranges from −1 to 1.
26. The method according to Clause 23, wherein the method comprises concentrating the acidic solution to an azeotrope concentration.
27. The method according to any one of Clauses 23 to 26, wherein concentrating the acidic solution comprises mechanical vapor recompression.
28. The method according to any one of Clauses 23 to 26, wherein concentrating the acidic solution comprises multi-effect evaporation.
29. The method according to any one of the preceding clauses, wherein the acidic solution comprises sulfuric acid (H₂SO₄).
30. The method according to any one of the preceding clauses, wherein the acidic solution comprises hydrochloric acid (HCl).
31. The method according to any one of the preceding clauses, wherein the acidic solution comprises hydrofluoric acid (HF).
32. The method according to any one of the preceding clauses, further comprising treating the regenerated aqueous sulfate prior to recirculating it to the electrolyzer stack.
33. The method according to Clause 32, wherein the method comprises concentrating the regenerated aqueous sulfate prior to recirculating it to the electrolyzer stack.
34. The method according to Clause 33, wherein the concentration of the regenerated aqueous sulfate ranges from 0.5 M to saturation.
35. The method according to any one of the preceding clauses, wherein the aqueous sulfate comprises sodium sulfate (Na₂SO₄).
36. The method according to any one of Clauses 1 to 34, wherein the aqueous sulfate comprises potassium sulfate (K₂SO₄).
37. The method according to any one of Clauses 1 to 34, wherein the aqueous sulfate comprises lithium sulfate (Li₂SO₄).
38. The method according to any one of Clauses 1 to 34, wherein the aqueous sulfate comprises ammonium sulfate ((NH₄)₂SO₄).
39. The method according to any one of the preceding clauses, wherein the extracted mineral comprises phosphorus.
40. The method according to Clause 39, wherein the method comprises using the acidic solution for phosphoric acid production.
41. The method according to Clause 39, wherein the sulfate waste product comprises phosphogypsum.
42. The method according to Clause 39, wherein the mineral source comprises rock phosphorus.
43. The method according to any one of the preceding clauses, wherein the extracted mineral is a silicate.
44. The method according to Clause 42, wherein the silicate is a mafic silicate material.
45. The method according to Clause 44, wherein the silicate is an ultramafic silicate material.
46. The method according to any one of the preceding clauses, wherein the extracted mineral comprises lithium (Li).
47. The method according to any one of the preceding clauses, wherein the extracted mineral comprises cobalt (Co).
48. The method according to any one of the preceding clauses, wherein the extracted mineral comprises a platinum group metal (PGM)
49. The method according to any one of the preceding clauses, wherein the PGM is selected from ruthenium, rhodium, palladium, osmium, iridium, and platinum.
50. The method according to any one of the preceding clauses, wherein the electrolyzing occurs at a current density ranging from 10 mA/cm² to 1,000 mA/cm².
51. The method according to any one of the preceding clauses, wherein the electrolyzing occurs at a cell voltage ranging from 3V to 7V.
52. The method according to any one of the preceding clauses, wherein extracting the mineral from the mineral source comprises a multi-stage neutralization to selectively recover a mixed hydroxide product.
53. A mineral extracted according to a method of any one of the preceding clauses.
54. A system comprising:
   an electrolyzer configured to electrolyze an aqueous sulfate to produce an acidic solution and a basic solution, the electrolyzer comprising an electrolyzer stack of one or more electrochemical cells comprising:
      an anode within an anode chamber containing an anolyte;
      a cathode within a cathode chamber containing a catholyte; and
      a cation exchange membrane separating the anode and cathode chambers;
   a reactor configured to extract a mineral from a mineral source using the acidic solution, thereby producing a sulfate waste product; and
   a precipitator configured to precipitate an inorganic alkaline solid formed from the sulfate waste product, thereby regenerating the aqueous sulfate;
   wherein the precipitator is fluidically connected to the electrolyzer stack such that the regenerated aqueous sulfate is recirculated to the electrolyzer stack for electrolysis.
55. The system according to Clause 54, wherein the cation exchange membrane configured so that sodium cation (Na⁺) crosses the cation exchange membrane to the cathode chamber.
56. The system according to Clause 54 or 55, wherein the one or more electrolysis cells further comprise an anion exchange membrane.
57. The system according to Clause 56, wherein the anion exchange membrane is configured so that sulfate anion (SO₄²⁻) crosses the anion exchange membrane to the anode chamber.
58. The system according to any one of Clauses 54 to 57, wherein the one or more electrolysis cells further comprise a bipolar membrane.
59. The system according to Clause 58, wherein the electrolyzer is configured for bipolar membrane electrodialysis (BMED).
60. The system according to any one of Clauses 54 to 59, further comprising a CO₂ sequestration unit.
61. The system according to Clause 60, wherein the CO₂ sequestration unit is configured to sequester gaseous CO₂ via direct air capture (DAC).
62. The system according to Clause 60, wherein the CO₂ sequestration unit is configured to sequester gaseous CO₂ from a point source.
63. The system according to Clause 62, wherein the point source comprises a flue gas.
64. The system according to any one of Clauses 60 to 63, wherein the CO₂ sequestration unit is configured to react gaseous CO₂ with the basic solution to produce an aqueous carbonate.
65. The system according to Clause 64, wherein the system is configured to concentrate the basic solution.
66. The system according to Clause 65, wherein the concentration of the basic solution ranges from 0.5 M to 2 M.
67. The system according to Clause 66, wherein the pH of the basic solution ranges from 13.7 to 14.3.
68. The system according to any one of Clauses 54 to 67, wherein the system is configured to concentrate the acidic solution.
69. The system according to Clause 68, wherein the concentration of the acidic solution is 0.1 M or greater.
70. The system according to Clause 68, wherein the pH of the acidic solution ranges from −1 to 1.
71. The system according to Clause 68, wherein the system is configured to concentrate the acidic solution to an azeotrope concentration.
72. The system according to any one of Clauses 68 to 71, wherein concentrating the acidic solution comprises mechanical vapor recompression.
73. The system according to any one of Clauses 68 to 71, wherein concentrating the acidic solution comprises multi-effect evaporation.
74. The system according to any one of Clauses 54 to 73, wherein the system is configured to treat the regenerated aqueous sulfate prior to recirculating it to the electrolyzer stack.
75. The system according to Clause 74, wherein the system is configured to concentrate the regenerated aqueous sulfate prior to recirculating it to the electrolyzer stack.
76. The system according to Clause 75, wherein the concentration of the regenerated aqueous sulfate ranges from 0.5 M to saturation.
77. The system according to any one of Clauses 54 to 76, wherein the electrolyzer is configured to operate at a current density ranging from 10 mA/cm² to 1,000 mA/cm².
78. The system according to any one of Clauses 54 to 77, wherein the electrolyzer is configured to operate at a cell voltage ranging from 3V to 7V.
79. The system according to any one of Clauses 54 to 78, wherein the reactor is operably connected to a mineral source comprising rock phosphorus.
80. The system according to any one of Clauses 54 to 79, wherein the reactor is configured to extract the mineral from the mineral source by a multi-stage neutralization to selectively recover a mixed hydroxide product.

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

Although the foregoing invention has been described in some detail by way of illustration and example for purposes of clarity of understanding, it is readily apparent to those of ordinary skill in the art in light of the teachings of this invention that certain changes and modifications may be made thereto without departing from the spirit or scope of the appended claims.

Accordingly, the preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. Moreover, nothing disclosed herein is intended to be dedicated to the public regardless of whether such disclosure is explicitly recited in the claims.

The scope of the present invention, therefore, is not intended to be limited to the exemplary embodiments shown and described herein. Rather, the scope and spirit of present invention is embodied by the appended claims. In the claims, 35 U.S.C. § 112(f) or 35 U.S.C. § 112(6) is expressly defined as being invoked for a limitation in the claim only when the exact phrase “means for” or the exact phrase “step for” is recited at the beginning of such limitation in the claim; if such exact phrase is not used in a limitation in the claim, then 35 U.S.C. § 112 (f) or 35 U.S.C. § 112(6) is not invoked.

What is claimed is:

1. A method comprising:
electrolyzing an aqueous sulfate to produce an acidic solution and a basic solution, wherein the electrolyzing comprises the use of an electrolyzer stack of one or more electrochemical cells comprising:
an anode within an anode chamber containing an anolyte;
a cathode within a cathode chamber containing a catholyte; and
a cation exchange membrane separating the anode and cathode chambers;
extracting a mineral from a mineral source using the acidic solution, thereby producing a sulfate waste product;
precipitating an inorganic alkaline solid formed from the sulfate waste product, thereby regenerating the aqueous sulfate; and
recirculating the regenerated aqueous sulfate to the electrolyzer stack for electrolysis.

2. The method according to claim 1, wherein the cation exchange membrane is configured so that sodium cation (Na⁺) crosses the cation exchange membrane to the cathode chamber.

3. The method according to claim 1, wherein the one or more electrolysis cells further comprise an anion exchange membrane.

4. The method according to claim 3, wherein the anion exchange membrane is configured so that sulfate anion (SO₄²⁻) crosses the anion exchange membrane to the anode chamber.

5. The method according to claim 1, wherein the one or more electrolysis cells further comprise a bipolar membrane and the method comprises bipolar membrane electrodialysis (BMED).

6. The method according to claim 1, wherein the method comprises a CO₂ sequestering protocol.

7. The method according to claim 6, wherein the CO₂ sequestering protocol comprises reacting gaseous CO₂ with the basic solution to produce an aqueous carbonate solution.

8. The method according to claim 7, further comprising concentrating the basic solution.

9. The method according to claim 1, wherein the method comprises concentrating the acidic solution.

10. The method according to claim 1, wherein the inorganic alkaline solid is selected from precipitated calcium carbonate (PCC), magnesium carbonate (MgCO₃), magnesium hydroxy carbonate (Mg₅(CO₃)₄(OH)₂·nH₂O), a calcium hydroxide alkaline solid product, and a magnesium hydroxide alkaline solid product.

11. The method according to claim 1, wherein the aqueous sulfate is selected from sodium sulfate (Na₂SO₄), potassium sulfate (K₂SO₄), lithium sulfate (Li₂SO₄), and ammonium sulfate ((NH₄)₂SO₄).

12. The method according to claim 1, wherein the extracted mineral comprises phosphorus and the sulfate waste product comprises phosphogypsum.

13. The method according to claim 1, wherein the extracted mineral is selected from a silicate, lithium (Li), cobalt (Co), and a platinum group metal (PGM).

14. A mineral extracted according to a method of claim 1.

15. A system comprising:
an electrolyzer configured to electrolyze an aqueous sulfate to produce an acidic solution and a basic solution, the electrolyzer comprising an electrolyzer stack of one or more electrochemical cells comprising:
an anode within an anode chamber containing an anolyte;
a cathode within a cathode chamber containing a catholyte; and
a cation exchange membrane separating the anode and cathode chambers;
a reactor configured to extract a mineral from a mineral source using the acidic solution, thereby producing a sulfate waste product; and
a precipitator configured to precipitate an inorganic alkaline solid formed from the sulfate waste product, thereby regenerating the aqueous sulfate;
wherein the precipitator is fluidically connected to the electrolyzer stack such that the regenerated aqueous sulfate is recirculated to the electrolyzer stack for electrolysis.

16. The system according to claim 15, wherein the cation exchange membrane configured so that sodium cation (Na⁺) crosses the cation exchange membrane to the cathode chamber.

17. The system according to claim 15, wherein the one or more electrolysis cells further comprise an anion exchange membrane.

18. The system according to claim 17, wherein the anion exchange membrane is configured so that sulfate anion (SO₄²⁻) crosses the anion exchange membrane to the anode chamber.

19. The system according to claim 15, wherein the one or more electrolysis cells further comprise a bipolar membrane.

20. The system according to claim 19, wherein the electrolyzer is configured for bipolar membrane electrodialysis (BMED).
